(19) United States
(12) Patent Application Publication
(10) Pub. No.: US 2026/0050542 A1
(43) Pub. Date: Feb. 19, 2026

(54) INFORMATION PROCESSING APPARATUS, INFORMATION PROCESSING METHOD, AND PROGRAM

(71) Applicant: SONY SEMICONDUCTOR SOLUTIONS CORPORATION, KANAGAWA (JP)

(72) Inventors: Munetake EBIHARA, KANAGAWA (JP); Kazuhiro MORIKAWA, KANAGAWA (JP)

(21) Appl. No.: 19/101,588

(22) PCT Filed: Jul. 27, 2023
(86) PCT No.: PCT/JP2023/027505

§ 371 Date: Feb. 5, 2025

(30) Foreign Application Priority Data
Aug. 10, 2022 (JP) 2022-127753

(51) Int. Cl. G06F 11/3698

(52) U.S. Cl. CPC G06F 11/3698

(57) ABSTRACT

The present disclosure relates to an information processing apparatus, an information processing method, and a program that enables mining processing performed in distributed consensus formation of blockchains to be effectively utilized. By replacing mining processing with processing of searching for an AI model that satisfies a predetermined condition, since a searched AI model itself has productivity, a huge amount of resources and enormous power consumption associated with the mining processing can be effectively utilized. The present disclosure can be applied to a blockchain.

### TECHNICAL FIELD

The present disclosure relates to an information processing apparatus, an information processing method, and a program and, particularly, to an information processing apparatus, an information processing method, and a program that enable mining processing performed in distributed consensus formation of a blockchain to be effectively utilized.

### BACKGROUND ART

When adding a new block in a blockchain, it is necessary to repeat processing of computing hash values while changing a nonce contained in information to be hashed until a hash value that satisfies a predetermined condition is obtained by processing called mining as described as proof-of-work for implementing a distributed timestamp server in the Bitcoin white paper authored by Satoshi Nakamoto.

When a hash value that satisfies the predetermined condition is calculated, a user (miner) having calculated the hash value that satisfies the predetermined condition is paid a predetermined amount of virtual currency or the like as a reward for the computation and a new block is added.

The computation to obtain a hash value is unproductive processing, as it is simply computation processing of repeating computations using a hash function while changing a nonce contained in a hash target until a hash value that satisfies the predetermined condition is found.

However, mining for the objective of acquiring rewards is an enormous waste of power consumption on a global scale, given that vast amount of computation processing are repeated on a daily basis while making full use of enormous resources.

In consideration thereof, a technique has been proposed to obtain a hash value using a part of information stored in a block instead of a nonce so that whether or not data stored in the block has been tampered with, erased, or the like can be appropriately verified while obtaining the hash value (refer to PTL 1).

### CITATION LIST

### Patent Literature

### [PTL 1]

WO 2018/211834

### SUMMARY

### Technical Problem

However, although the technique described in PTL 1 can verify whether or not the data stored in blocks by mining has been tampered, erased, or the like, the computation processing performed by mining remains unproductive and it is difficult to say that the waste of power consumption on a global scale has been curbed.

The present disclosure has been made in view of such circumstances and, in particular, an object of the present disclosure is to enable products of mining processing that realizes distributed consensus formation performed in a blockchain to be effectively utilized by making mining processing productive processing.

### Solution to Problem

An information processing apparatus and a program according to an aspect of the present disclosure are an information processing apparatus and a program including a search unit configured to add a new block containing an identifier of the information processing apparatus to a blockchain held by each of a group of a plurality of distributed information processing apparatuses when the search unit searches for information that satisfies a predetermined condition first, wherein the information that satisfies the predetermined condition is an input setting value with respect to useful calculation processing that satisfies an evaluation condition of a predetermined output result.

An information processing method according to an aspect of the present disclosure is an information processing method including the step of adding a new block containing an own identifier to a blockchain held by each of a group of a plurality of distributed information processing apparatuses when information that satisfies a predetermined condition is first searched, wherein the information that satisfies the predetermined condition is an input setting value with respect to useful calculation processing that satisfies an evaluation condition of a predetermined output result.

In an aspect of the present disclosure, a new block containing an own identifier is added to a blockchain held by each of a group of a plurality of distributed information processing apparatuses when information that satisfies a predetermined condition is first searched, wherein the information that satisfies the predetermined condition is an input setting value with respect to useful calculation processing that satisfies an evaluation condition of a predetermined output result.

### BRIEF DESCRIPTION OF DRAWINGS

FIG. 1 is a diagram illustrating a configuration example of a general blockchain.

FIG. 2 is a diagram illustrating a configuration example of an information processing system that realizes mining of a general blockchain.

FIG. 3 is a flow chart illustrating general mining processing by the information processing system in FIG. 2.

FIG. 4 is a diagram illustrating general mining processing by the information processing system in FIG. 2.

FIG. 5 is a flow chart illustrating general verification processing by the information processing system in FIG. 2.

FIG. 6 is a diagram illustrating general verification processing by the information processing system in FIG. 2.

FIG. 7 is a flow chart illustrating an outline of mining processing according to the present disclosure.

FIG. 8 is a flow chart illustrating an outline of verification processing according to the present disclosure.

FIG. 9 is a diagram illustrating a configuration example of an information processing system according to the present disclosure.

FIG. 10 is a diagram illustrating a configuration example of an AI model developer terminal of the information processing system in FIG. 9.

FIG. 11 is a diagram illustrating a configuration example of an AI model development requestor terminal of the information processing system in FIG. 9.

FIG. 12 is a diagram illustrating a configuration example of a blockchain according to the present disclosure.

FIG. 13 is a diagram illustrating an outline of a lensless imaging apparatus.

FIG. 14 is a diagram illustrating computation processing in imaging processing of the lensless imaging apparatus in FIG. 13.

FIG. 15 is a diagram illustrating a flow of mining processing by the information processing system in FIG. 9.

FIG. 16 is a flow chart illustrating processing by an AI model development requestor terminal.

FIG. 17 is a flow chart illustrating mining processing by an AI model developer terminal.

FIG. 18 is a flow chart illustrating verification processing by an AI model developer terminal.

FIG. 19 is a diagram illustrating an outline of an application example of the present disclosure.

FIG. 20 is a diagram illustrating a configuration example of an information processing system that realizes an application example of the present disclosure.

FIG. 21 is a diagram illustrating each device that registers and downloads an AI model or an AI application via a marketplace function provided by a cloud-side information processing apparatus.

FIG. 22 is a diagram illustrating a connection mode of a cloud-side information processing apparatus and an edge-side information processing apparatus.

FIG. 23 is a functional block diagram of a cloud-side information processing apparatus.

FIG. 24 is a block diagram showing an internal configuration example of a camera.

FIG. 25 is a diagram showing a configuration example of an image sensor.

FIG. 26 is a block diagram showing a software configuration of a camera.

FIG. 27 is a block diagram showing an operating environment of a container when using containerization.

FIG. 28 is a block diagram showing an example of a hardware configuration of an information processing apparatus.

FIG. 29 is a diagram illustrating a flow of processing when an AI model is retrained and an edge-side AI model or AI application is updated.

FIG. 30 is a diagram showing an example of a login screen for logging into a marketplace.

FIG. 31 is a diagram showing an example of a developer's screen that is presented to each developer using a marketplace.

FIG. 32 is a diagram showing an example of a user's screen that is presented to each application-using user using a marketplace.

FIG. 33 is a diagram showing, together with FIG. 34, a flow of processing executed by each apparatus when registering or downloading an AI model or an AI application via a marketplace function.

FIG. 34 is a diagram showing, together with FIG. 33, a flow of processing executed by each apparatus when registering or downloading an AI model or an AI application via a marketplace function.

FIG. 35 is a diagram showing a configuration example of a general-purpose personal computer.

### DESCRIPTION OF EMBODIMENTS

Hereinafter, a preferred embodiment of the present disclosure will be described in detail with reference to the accompanying drawings. In the present specification and the drawings, components having substantially the same functional configuration will be denoted by same reference signs and overlapping descriptions thereof will not be repeated.

Hereinafter, modes for implementing the present technique will be described. The descriptions will be given in the following order.
1. Outline of present disclosure
2. Preferred embodiment
3. Application examples
4. Modifications
5. Example of execution by software

### 1. Outline of Present Disclosure

### <Example of General Configuration of Blockchain>

The present disclosure enables products of mining that realizes distributed consensus formation performed when a block is added in a blockchain to be effectively utilized by making computation processing related to mining productive processing.

In describing the present disclosure, first, a general configuration of a blockchain will be described.

Blockchains were developed as a technique for realizing a ledger of virtual currency based on distributed consensus formation by an application of a distributed timestamp server.

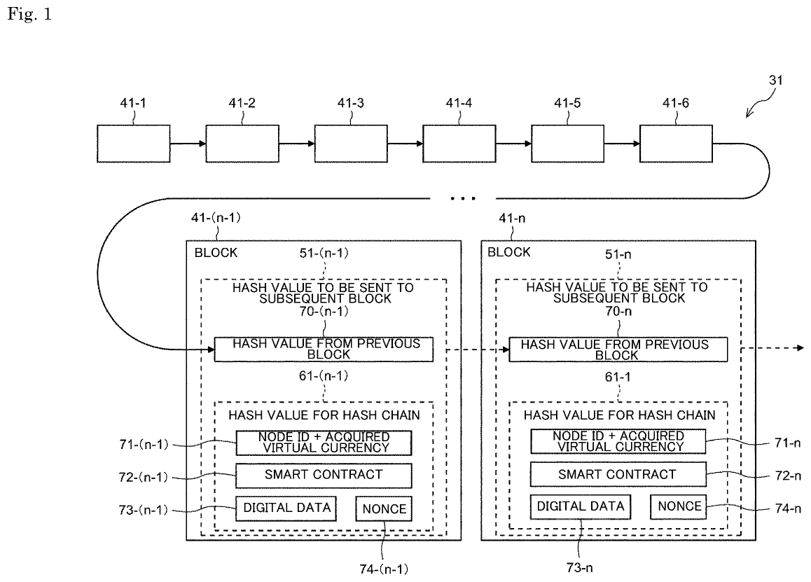

FIG. 1 shows a structure example of a general blockchain. A blockchain 31 shown in FIG. 1 is structured such that n-number of blocks from block 41-1 to block 41-n are linked together as if they were a chain. Hereinafter, when there is no need to distinguish among blocks 41-1 to 41-n, the blocks shall simply be referred to as a block 41, and other components shall be referred to in a similar manner.

Each 41 block includes a hash value 70 from a previous block, a node ID and earned virtual currency (node ID+earned virtual currency) 71, a smart contract 72, digital data 73, and a nonce 74.

The hash value 70 from a previous block is a hash value obtained when the block 41 constituting the blockchain 31 is added from data of the previous block 41.

The node ID and earned virtual currency 71 are a node ID that identifies a node having succeeded in so-called mining when the block 41 that constitutes the blockchain 31 is added and information on virtual currency that is acquired as a reward for the node being the first to compute a hash value that satisfies a predetermined condition through mining.

The smart contract 72 is a code for executing a program to carry out contractual matters for handling the blockchain 31. However, since the program for carrying out the contractual matters for handling the blockchain 31 may be executed separately, the smart contract 72 is not an essential component.

The digital data 73 is data of which integrity is to be managed and which is typically constituted of one or two or more transactions, and examples of the digital data 73 include information of a record of deposits and withdrawals of virtual currency. However, the digital data 73 is not limited to information of a record of deposits and withdrawals of virtual currency and may be an image, a video, a blueprint, music, a text, software, an AI (Artificial Intelligence) model, or other digital works of which integrity is to be managed.

The nonce 74 is information used to determine a node to which a new block 41 is to be added from a plurality of nodes connected to a P2P network or, in other words, information used in mining processing.

The hash value 70 from a previous block is information linking an immediately preceding block to the present block and examples include a hash value or the like of an entire piece of data contained in the immediately preceding block 41 (or a part of data contained in the immediately preceding block 41).

In addition, the hash value 70 from a previous block includes a function of detecting a presence or absence of tampering or the like of data contained in each block 41 of the blockchain 31. More specifically, if the digital data 73 of which integrity is to be managed contained in any of the blocks 41 of the blockchain 31 is tampered with, since the hash value of the entire piece of data contained in the present block 41 (or a part of the data contained in the present block) changes and discrepancies arise in the hash value 70 from a previous block that is contained in the blocks 41 subsequent to the present block 41, tampering of data is detected.

When the algorithm for distributed consensus formation is Proof of Work, a plurality of nodes connected to a P2P network search for the nonce 74 that satisfies a predetermined condition, and when the nonce 74 searched first is verified by the nodes other than the node having searched the nonce 74 first, a new block 41 is added. At this point, the node (user of the node) having searched the nonce 74 that satisfies the predetermined condition first earns a predetermined amount of virtual currency as a reward.

The nonce 74 that satisfies the predetermined condition is the nonce 74 that becomes, when a hash value of an entire piece of data contained in the block 41 (or a part of the data contained in the block) is obtained while variously changing the nonce 74 in the block 41 to be added, a hash value smaller than a predetermined value (a hash value where a predetermined number of bits from a first bit is 0).

The processing of searching for the nonce 74 is processing of obtaining hash values by inputting the nonce 74 into a hash function while changing the nonce 74 by round-robin and searching for a hash value satisfying the predetermined condition. Therefore, the processing solves a task in that a success rate (a probability of finding a hash value that satisfies the predetermined condition first) increases in accordance with computational power, and the higher the performance of hardware and software that make up the node, the greater the likelihood of early discovery. The processing of searching for the nonce 74 is so-called mining.

### <Mining>

Next, Proof of Work in a distributed timestamp server, or so-called mining, will be explained using a more specific example.

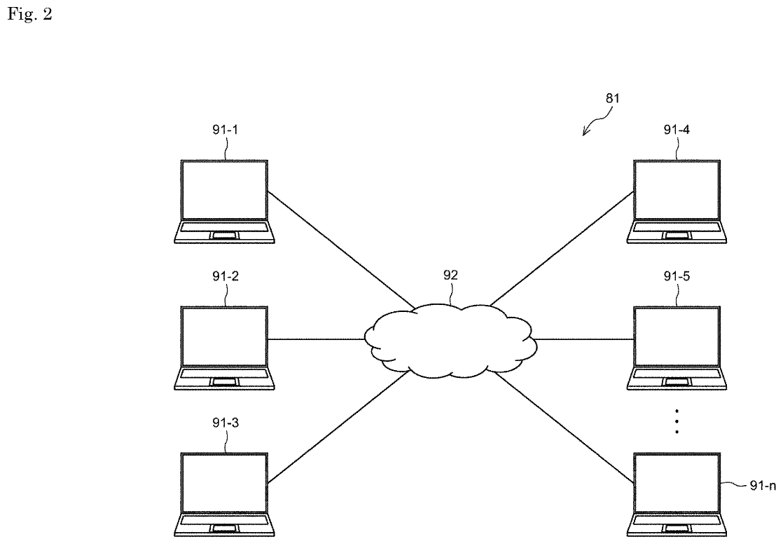

Here, as shown in FIG. 2, it is assumed that there is an information processing system 81 that manages a blockchain including a plurality of nodes 91-1 to 91-n that execute mining connected via a network 92 represented by a P2P network.

A case where, for example, a block 41-(n−1) is an End of the Blockchain 31 Will be considered.

More specifically, each node 91 executes mining processing, concatenates a value made up of node ID+acquired virtual currency 71-(n−1), a smart contract 72-(n−1), digital data 73-(n−1), and a nonce 74-(n−1), and computes a hash value 61-(n−1) for a hash chain using a hash function.

In doing so, each node 91 searches for the hash value 61-(n−1) for a hash chain that satisfies a predetermined condition such as being smaller than a predetermined value (for example, 0s are lined up for a predetermined number of bits from the first bit) by repeatedly computing the hash value 61-(n−1) for a hash chain while changing the nonce 74-(n−1).

In addition, the node 91 having computed the hash value 61-(n−1) for a hash chain that satisfies the predetermined condition first broadcasts to the other nodes 91 that it has searched the nonce 74-(n−1) to compute the hash value 61-(n−1) for a hash chain that satisfies the predetermined condition.

At this time, the nonce 74-(n−1) obtained by the node 91 having computed the nonce 74-(n−1) of the hash value 61-(n−1) for a hash chain that satisfies the predetermined condition first is also broadcasted.

After concatenating the hash value 70-(n−1) from the previous block with the hash value 61-(n−1) for a hash chain that satisfies the predetermined condition, the node 91 having computed the hash value 61-(n−1) for a hash chain first substitutes the concatenated value into a hash function to obtain a hash value 51-(n−1) to be sent to a subsequent block. In addition, the node 91 having succeeded in mining extends a blockchain 201 by using the hash value 51-(n−1) to be sent to a subsequent block as a hash value 70-n of a new block 41-n.

Furthermore, the other nodes 91 having acquired the broadcasted nonce 74-(n−1) compute the hash value 61-(n−1) for a hash chain using the nonce 74-(n−1) and execute verification processing of verifying that the predetermined condition is satisfied.

When it is verified by the verification processing that the hash value 61-(n−1) for a hash chain obtained by a computation using the broadcasted nonce 74-(n−1) is a hash value that satisfies the predetermined condition, the other nodes 91 concatenate the hash value 70-(n−1) from the previous block with the hash value 61-(n−1) for a hash chain and obtains the concatenated value as a hash value 51-(n−1) to be sent to a subsequent block.

In addition, the blockchain 201 is extended due to the hash value 51-(n−1) to be sent to a subsequent block being used as the hash value 70-n of the new block 41-n.

As described above, through mining processing and verification processing, a distributed consensus constituted of Proof of Work is formed by each of all of the nodes 91 connected to the network 92 represented by the P2P network and the new block 41-n is added to the blockchain 31.

### <General Mining Processing>

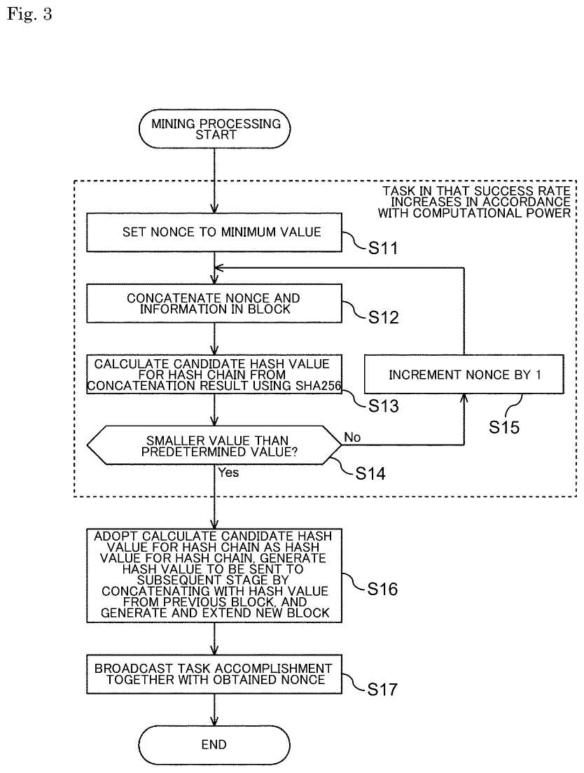

Next, details of general mining processing will be described with reference to a flow chart shown in FIG. 3.

In step S11, the node 91 sets the nonce 74-(n−1) to a minimum value.

In step S12, the node 91 concatenates a value made up of node ID of the block 41-(n−1)+acquired virtual currency 71-(n−1), the smart contract 72-(n−1), the digital data 73-(n−1), and the nonce 74-(n−1).

In step S13, the node 91 computes a candidate hash value for a hash chain from the concatenation result using a hash function such as SHA-256.

In step S14, the node 91 determines whether or not the computed candidate hash value for a hash chain satisfies a predetermined condition that is being smaller than a predetermined value such as a value that is 0 for a predetermined number of bits from the first bit.

When the computed candidate hash value for a hash chain is not smaller than the predetermined value in step S14, the processing advances to step S15.

In step S15, the nonce 74-(n−1) is incremented by 1 and the processing returns to step S12.

In other words, the processing of steps S12 to S15 is repeated until the computed candidate hash value for a hash chain is determined to satisfy a predetermined condition of being smaller than a predetermined value such as a value that is 0 for a predetermined number of bits from the first bit.

When the computed candidate hash value for a hash chain is determined to satisfy a predetermined condition of being smaller than a predetermined value such as a value that is 0 for a predetermined number of bits from the first bit in step S14, the processing advances to step S16.

In step S16, the node 91 adopts the computed candidate hash value for a hash chain as the computed hash value 61-(n−1) for a hash chain, generates the hash value 51-(n−1) to be sent to a subsequent stage together with the hash value 70-(n−1) from the previous block using the hash function SHA-256, generates and connects a new block 41-n by using the hash value 51-(n−1) to be sent to a subsequent stage as the hash value 70-n, and extends the blockchain 31.

In step S17, the node 91 broadcasts accomplishment of the task, along with information on the nonce 74-(n−1) applied to the computation of the hash value 61-(n−1) for a hash chain that satisfies the predetermined condition, to the other nodes 91.

Due to the broadcast, the node (the user of the node) 91 having computed the nonce 74-(n−1) of the hash value 61-(n−1) for a hash chain that satisfies the predetermined condition first can earn virtual currency as a reward for the first computation.

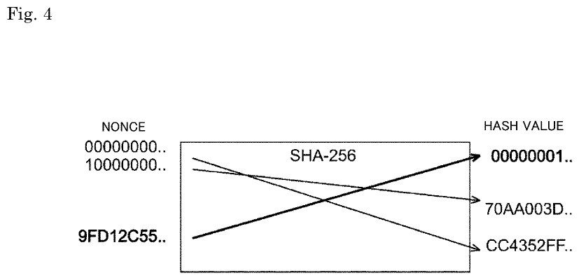

In other words, in the processing described above, in particular, processing of computing a candidate of the hash value 61-(n−1) for a hash chain is repeated while changing the nonce 74-(n−1) in a round-robin as shown in FIG. 4 by the processing of steps S11 to S15.

In addition, the task is accomplished once the predetermined condition is satisfied such as computing a candidate in which a predetermined number of 0s are arranged from the beginning or, in other words, computing a candidate that is smaller than a predetermined value, the computed candidate is considered the hash value 61-(n−1) for a hash chain, the hash value 61-(n−1) for a hash chain is broadcasted to the other nodes 91 together with the nonce 74-(n−1) at that time, the accomplishment of the task is notified, and a new block 41 is extended.

In FIG. 4, a left part represents the nonce 74-(n−1), a right part represents a candidate of the hash value 61-(n−1) for a hash chain that is computed by substituting the nonce 74-(n−1) into a hash function constituted of SHA-256, and FIG. 4 shows, from the top of the diagram, how candidates of a corresponding hash value 61-(n−1) for a hash chain are computed by changing the nonce 74-(n−1) in a round-robin.

In addition, FIG. 4 shows that when the nonce 74-(n−1) is “9FD12C55 . . . ”, a candidate satisfying the predetermined condition of being smaller than a predetermined value (in FIG. 4, a candidate having seven 0s lined up from a first bit) is computed and the task is accomplished.

### <General Verification Processing>

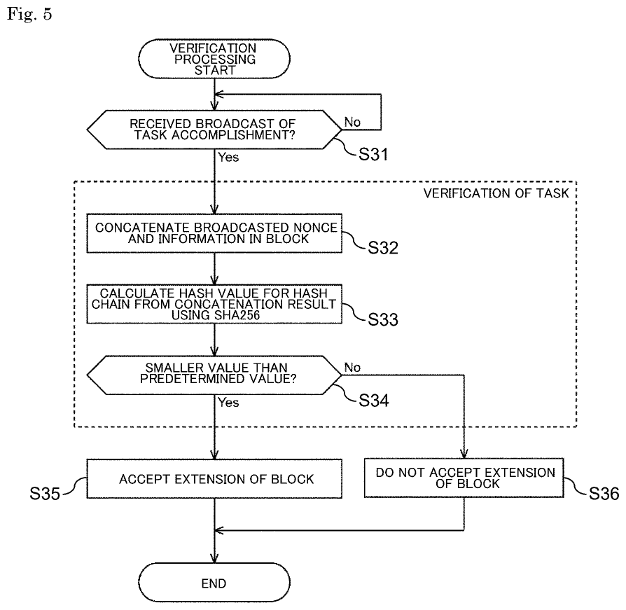

General verification processing will now be described with reference to a flow chart shown in FIG. 5.

In step S31, the node 91 determines whether or not a broadcast of task accomplishment has been received from another node 91 and repeats similar processing until such a broadcast is received.

When a broadcast of task accomplishment has been received from another node 91 in step S31, the processing advances to step S32.

In step S32, the node 91 concatenates a value made up of the broadcasted nonce 74-(n−1), the node ID of the block 41-(n−1)+acquired virtual currency 71-(n−1), the smart contract 72-(n−1), and the digital data 73-(n−1).

In step S33, the node 91 computes a hash value 61-(n−1) for a hash chain from the concatenation result using SHA-256 that is a hash function.

In step S34, the node 91 determines whether or not the computed hash value 61-(N−1) for a hash chain satisfies a predetermined condition that is being smaller than a predetermined value such as a value that is 0 for a predetermined number of bits from the first bit and performs verification.

When the computed candidate hash value 61-(n−1) for a hash chain is smaller than the predetermined value and satisfies the predetermined condition in step S34, the processing advances to step S35.

In step S35, the node 91 accepts an extension of the broadcasted block 41 and extends the blockchain 31 by generating a new block 41-n using the nonce 74-(n−1) and linking the new block 41-n to the blockchain 31.

On the other hand, when the computed hash value 61-(n−1) for a hash chain does not satisfy the predetermined condition in step S34, the processing advances to step S36.

In step S36, the node 91 does not accept an extension of the broadcasted block 41 and does not extend the blockchain 31.

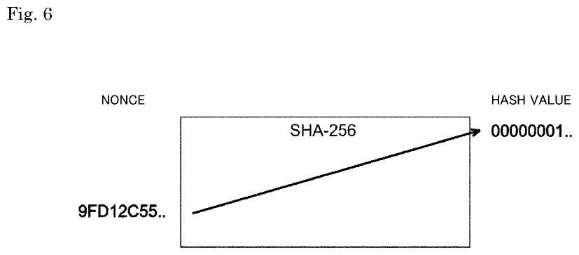

In other words, in the processing described above, in particular, in processing of steps S32 to S34, the hash value 61-(n−1) for a hash chain computed from the broadcasted nonce 74-(n−1) is verified according to a predetermined condition such as whether or not the hash value 61-(n−1) for a hash chain is a hash value with a predetermined number of 0s arranged from the first bit as shown in FIG. 6 and a new block is extended when the predetermined condition is satisfied.

FIG. 6 shows that when the broadcasted nonce 74-(n−1) is “9FD12C55 . . . ”, a candidate satisfying the predetermined condition of having seven 0s lined up from a first bit is computed and an accomplishment of the task has been confirmed by verification.

As described above, in the blockchain 31, mining processing is performed by a plurality of nodes 91, and the node 91 having been able to compute a nonce satisfying a predetermined condition first adds its own block based on a computation result and broadcasts the task accomplishment to the other nodes 91.

In addition, when the task accomplishment is broadcasted, the other nodes 91 execute verification processing using the broadcasted nonce and add the block when the verification is confirmed.

As a result, the extension of a block in the blockchain 31 or, in other words, the management of the digital data 73 of which integrity is to be managed in the blockchain 31 is realized by distributed consensus formation among the respective nodes 91 connected via the network 92 without involving a centralized management server or the like.

In mining processing, as described with reference to steps S11 to S15 in FIG. 3, the processing of obtaining a nonce that yields a hash value satisfying a predetermined condition can be described as processing of solving a task in that a success rate increases in accordance with computational power determined by performance of a computing apparatus or the like.

Nevertheless, the processing that is actually being performed is unproductive processing of simply changing a nonce in a round-robin to find a hash value that satisfies a condition as described with reference to FIG. 4.

However, given that an owner of the node 91 executing the mining processing constructs a computing apparatus providing higher performance and repeats the mining processing on a daily basis while consuming enormous amounts of power in order to acquire the virtual currency that serves as the reward, considering the high-performance computing apparatus used under heavy loads, it is difficult to say that the results of the computations are being effectively utilized.

In consideration thereof, in the present disclosure, effective utilization of a product of mining processing is enabled by changing the task in that a success rate increases in accordance with computational power to a productive task and effective utilization of the mining processing itself is enabled by making a computation result obtained by the high-load processing performed by a high-performance computing apparatus meaningful.

A productive task of which a success rate increases in accordance with computational power is, for example, development of an AI model that solves a predetermined task or generation of a data set used the development of an AI model that solves a predetermined task.

In other words, in the present disclosure, processing of accepting a request to solve a task in that a success rate increases in accordance with computational power such as the development of an AI model or the generation of a data set to be used to develop an AI model and processing of solving the task according to the request is considered mining processing.

Accordingly, the mining processing according to the present disclosure becomes highly productive processing, a computation result obtained by high-load processing related to the mining processing performed by a high-performance computing apparatus can be made more meaningful, and the mining processing can be effectively utilized.

### <Outline of Mining Processing According to Present Disclosure>

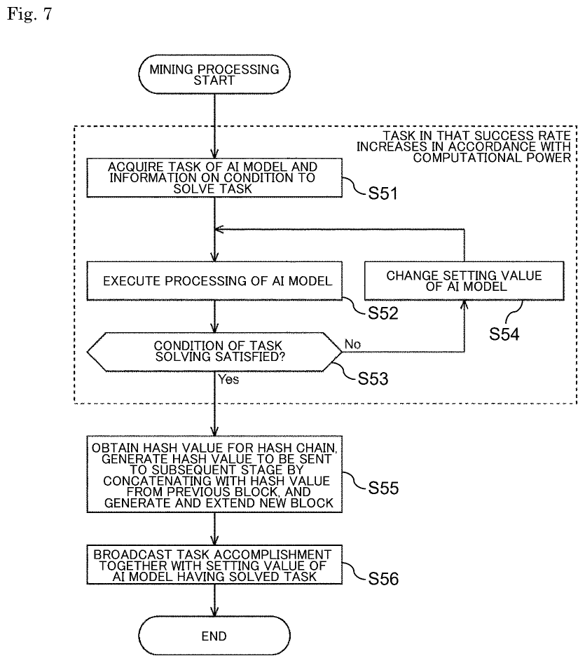

Next, an outline of mining processing according to the present disclosure will be described with reference to a flow chart shown in FIG. 7.

While the task in that a success rate increases in accordance with computational power described above is assumed to be a task of finding a setting value of an AI model (parameter of the AI model) for solving a predetermined task, the task is simply an example and any other task may be adopted.

In step S51, the node 91 acquires a task of an AI model and information on a condition to solve the task.

In step S52, the node 91 causes the AI model to execute processing according to a predetermined setting value.

In step S53, the node 91 determines whether or not a result of using the AI model configured to the predetermined setting value satisfies the condition for task solution.

When it is determined in step S53 that the developed AI model does not satisfy the condition for task solution, the processing advances to step S54.

In step S54, the node 91 changes the setting value of the AI model and the processing returns to step S52. Examples of specific candidates for changing the setting value of the AI model include Hyperparameter, Weight, image data preprocessing (for example, parameters for normalization, resizing, a histogram, or dimensional compression), image data augmentation (change parameters such as flipping, rotating, cropping, brightness, and color temperature as data augmentation), Sentence Split, Tokenization, POS tagging, Lemmatization, Dependency Parsing, NER, and parameters of regularization methods (L2 regularization and dropout) as preprocessing including languages.

In other words, in step S53, processing of executing the AI model is repeated while changing setting values until it is determined that the condition for task solution is satisfied. Examples of a specific candidate for the condition for task solution include scores of Accuracy, Precision, Recall, F value (Dice coefficient), IoU (Jaccard coefficient), BLEU, and overfit (overlearning) status to Training data set.

When it is determined in step S53 that the condition for task solution is satisfied by executing the AI model, the processing advances to step S55.

In step S55, the node 91 obtains a hash value of information that specifies the solved task and obtains a hash value for a hash chain together with information in a block. In addition, the node 91 concatenates the hash value for a hash chain and the hash value from the previous block to calculate a hash value to be sent to a subsequent stage and generates and extends a new block.

In step S56, the node 91 broadcasts task accomplishment to the other nodes 91 together with the information on the setting value of the AI model having solved the task.

In other words, in the processing described above, in particular, processing executed while changing the setting value of a AI model to solve a predetermined task is repeated as the processing of steps S51 to S54, information identifying the task is obtained as a hash value when the task is accomplished, a hash value to be set to a subsequent block together with other information in a block is obtained, and a new block is extended.

In addition, when the task is accomplished, information on the task accomplishment and the setting value having accomplished the task are broadcast to the other nodes 91.

The node 91 (user of the node) having accomplished the task first can acquire, for example, a predetermined amount of virtual currency as a reward for developing a setting of the AI model.

### <Outline of Verification Processing According to Present Disclosure>

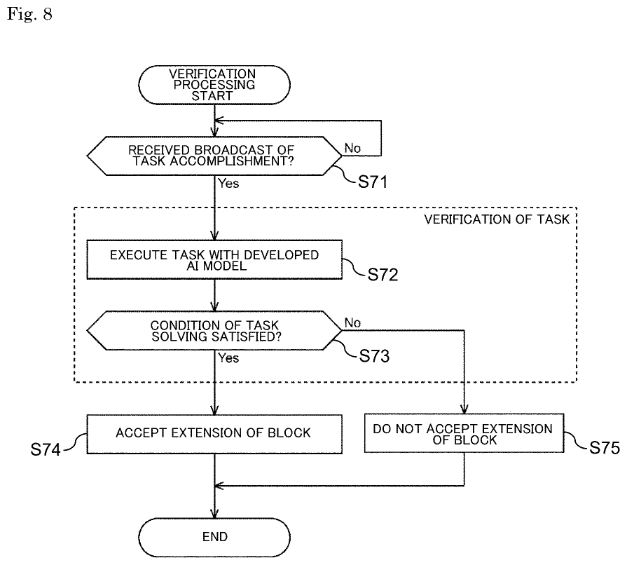

Next, an outline of verification processing according to the present disclosure will be described with reference to a flow chart shown in FIG. 8.

In step S71, the node 91 determines whether or not a broadcast of task accomplishment has been received from another node 91 and repeats similar processing until such a broadcast is received.

When a broadcast of task accomplishment has been received from another node 91 in step S71, the processing advances to step S72.

In step S72, the node 91 executes the AI model configured on the basis of the broadcasted setting value of an AI model or, in other words, the AI model having accomplished the task.

In step S73, the node 91 determines whether or not a result of executing the AI model satisfies the condition for task solution and performs verification.

In step S73, when the execution result of the AI model to which a setting based on a developed hash value has been applied satisfies the condition for task solution, the processing advances to step S74.

In step S74, the node 91 accepts an extension of the broadcasted block 41 and extends the blockchain 31 by generating a new block 41-n using the developed hash value and linking the new block 41-n to the blockchain 31.

On the other hand, when the execution result of the AI model to which a setting based on a developed hash value has been applied does not satisfy the condition for task solution in step S73, the processing advances to step S75.

In step S75, the node 91 does not accept an extension of the broadcasted block 41 and does not extend the blockchain 31.

In other words, while the processing of steps S51 to S54 in the mining processing shown in FIG. 7 is processing of solving the task in that a success rate increases in accordance with computational power as described above, contents of the processing will be productive processing which is realized by the AI model to solve actual tasks.

As a result, even if the owner of each node 91 improves computation capability and consumes a huge amount of power for computations in order to acquire virtual currency as a reward for task solution, since the mining processing itself becomes highly productive processing, processing results of the mining processing can be effectively utilized and the consumption of the huge amount of power and use of high-performance resources can also be made effective.

### 2. Preferred Embodiment

### <Example of Configuration of Information Processing System>

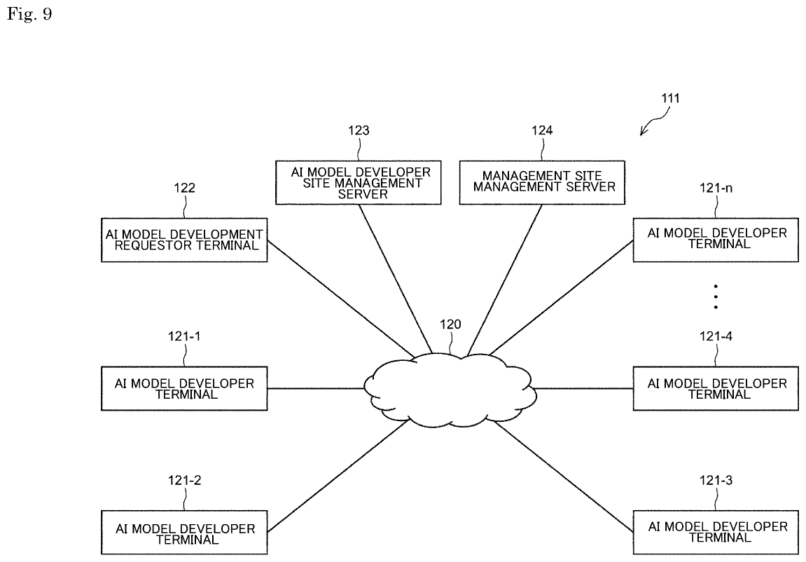

Next, a configuration example of an information processing system which makes mining processing (search processing) itself that realizes distributed consensus formation in a blockchain according to the present disclosure highly productive processing and which enables a processing result of the mining processing and power consumption and resources necessary for the processing to be effectively utilized will be described with reference to FIG. 9.

An information processing system 111 shown in FIG. 9 is constituted of AI model developer terminals 121-1 to 121-n, an AI model development requestor terminal 122, an AI model developer site management server 123, and a management site management server 124 and the components can communicate with each via a network 120 constituted of a P2P network.

The AI model developer terminals 121-1 to 121-n are components that correspond to the nodes 91-1 to 91-n in FIG. 2.

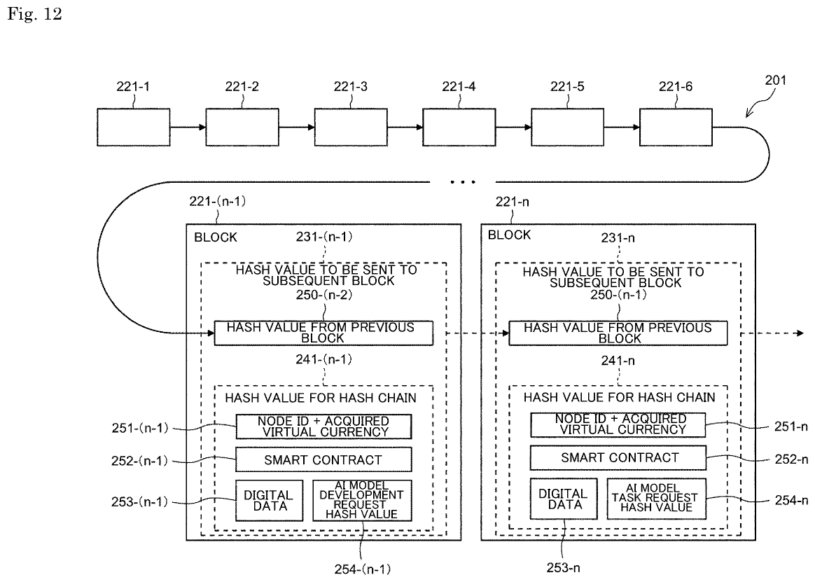

The AI model developer terminal 121 is a computer operated by an AI model developer and executes development processing of an AI model as mining processing for extending a new block of the blockchain 201 (FIG. 12).

In this example, the AI model developer acts as a miner to perform the mining processing, and the AI model developer as a miner executes development processing of an AI model to solve a predetermined task using the AI model developer terminal 121 as the mining processing.

In addition, when the development task is accomplished by the development of an AI model using the AI model developer terminal 121, a new block 221 (FIG. 12) is extended and the AI model developer terminal 121 (an AI developer thereof) acquires a reward for the development of the AI model. The reward may be in the form of a predetermined amount of virtual currency or having the AI model developed bought up.

The AI model development requestor terminal 122 is a computer operated by an AI model development requestor who requests development of an AI model to be a task in mining processing.

The AI model development requestor terminal 122 is operated by the AI model development requestor and uploads an AI model of which development is to be requested, a development task, an environment, a condition for accomplishment, and a reward that can be acquired when the development task is accomplished to an AI model developer's website or a public site such as an SNS being managed by the AI model developer site management server 123.

The AI model development requestor terminal 122 uploads information such as various software simulators considered necessary for development of the AI model of which development is to be requested and various source codes considered necessary for the development to a source code management site or an image data management site managed by the management site management server 124.

The AI model development requestor terminal 122 records various kinds of information related to the AI model development request as a smart contract 252 (FIG. 12) in a transaction within each block 221 (FIG. 12) of the blockchain 201 (FIG. 12).

In this case, the various kinds of information related to the AI model development request that are recorded as the smart contract 252 (FIG. 12) includes information on a node ID that identifies the AI model development requestor terminal 122, a request destination node condition, the AI model of which development is to be requested, a development task, an environment (a tool considered necessary for development), a condition for accomplishment, and a reward that can be acquired when the task is accomplished by the development, or a URL of a site managed by the AI model developer site management server 123 to which the pieces of information are uploaded.

Furthermore, the various kinds of information related to the AI model development request that are recorded as the smart contract 252 (FIG. 12) includes a software simulator or an evaluation index calculation tool considered necessary for development of the AI model of which development is to be requested, information such as various kinds of source codes considered necessary for development, or a URL of a site managed by the management site management server 124 to which the pieces of information are uploaded.

The AI model developer terminal 121 is operated by the AI model developer and, for example, accesses the AI model developer site management server 123 to acquire the AI model of which development is to be requested, the development task, the environment, the condition for accomplishment, and the reward that can be acquired when the task is accomplished by the development and presents the information to the AI model developer.

When the AI model developer is about to accept the development request for an AI model based on the presentation, the AI model developer terminal 121 is operated by the AI model developer and accesses the blockchain 201.

When the AI model developer terminal 121 accesses the blockchain 201, the AI model developer terminal 121 checks the various kinds of information related to the AI model development request and acquires the software simulator considered necessary for development of the AI model or information such as various kinds of source codes considered necessary for development based on the smart contract 252 (FIG. 12).

The AI model developer terminal 121 is operated by the AI model developer and, based on the pieces of information, executes development processing of the AI model for realizing task accomplishment as mining processing. The mining processing as development of an AI model that realizes task accomplishment is to be performed by a plurality of AI model developer terminals 121 and, among the plurality of AI model developer terminals 121, the AI model developer terminal 121 (the AI model developer thereof) having accomplished the task first can acquire the reward related to the development.

Note that the development of an AI model can be carried out by collaboration by a plurality of AI model developers using a plurality of AI model developer terminals 121.

More specifically, for example, when the AI model developer terminal 121-1 among the AI model developer terminals 121-1 to 121-n was able to accomplish the development task first by the AI model development processing as mining processing, the AI model developer terminal 121-1 adds a new block 221 (FIG. 12) and extends the blockchain 201 (FIG. 12), broadcasts information indicating that the task was accomplished and information on the developed AI model to the other AI model developer terminals 121-2 to 121-n using the smart contract 252.

More specifically, the AI model developer terminal 121-1 records and broadcasts a hash value of the smart contract 252 of a request source, a node ID of the AI model developer terminal 121, a hash value of information of the developed AI model (for example, a setting value when the task accomplishment is realized), a URL at which the AI model having realized the task accomplishment is to be published, and the like as the smart contract 252.

When task accomplishment and information on the developed AI model are broadcasted by the AI model developer terminal 121-1 having accomplished the task first, the other AI model developer terminals 121-2 to 121-n execute verification processing to verify whether the task has been accomplished or not on the basis of the broadcasted information of the AI model, and when it is verified that the task accomplishment has been realized, the new block 221 (FIG. 12) is added and the blockchain 201 (FIG. 12) is extended.

When the new block 221 (FIG. 12) is added and the blockchain 201 (FIG. 12) is extended, the node ID of the AI model developer terminal 121 having realized the task accomplishment and the like are stored together with the reward for the development of the AI model, and the various kinds of information related to the AI model development request, information related to the AI model having realized the task accomplishment, and the fact that a series of contractual acts such as payment of remuneration has been completed are recorded as the smart contract 252 of a new transaction.

Such a configuration enables high-cost mining processing using high-performance computing apparatuses which is considered necessary for distributed consensus formation constituted of Proof of Work of a blockchain to be made productive and effective processing such as the development of AI models.

Consequently, since a result of the mining processing becomes a result of the development of an AI model, the mining processing itself can be made highly productive processing and the enormous computing costs and resources associated with the mining processing can be effectively utilized.

In addition, since a smart contract in the blockchain can realize a development request, payment of rewards, transactions of deliverables, and the like, there is no need to prepare a server or the like for managing such processing in a centralized manner.

### <Example of Configuration of AI Model Developer Terminal>

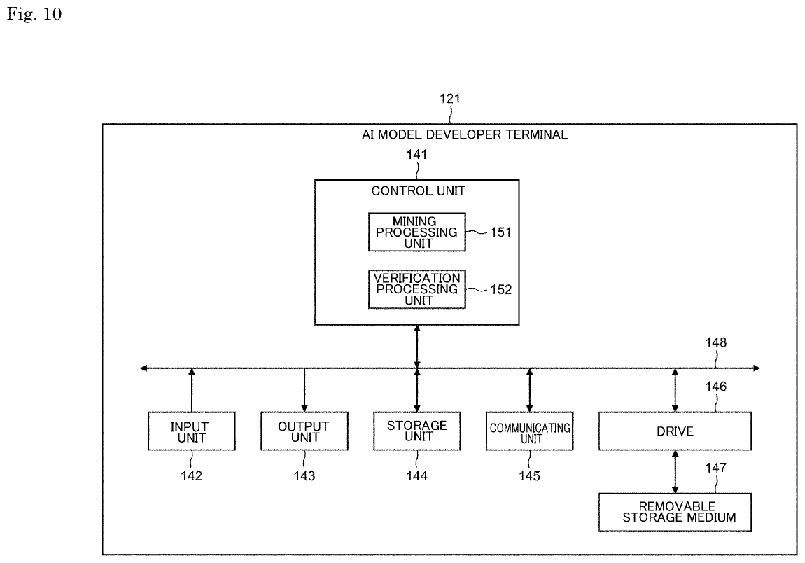

Next, a configuration example of the AI model developer terminal 121 will be described with reference to FIG. 10.

The AI model developer terminal 121 is constituted of a control unit 141, an input unit 142, an output unit 143, a storage unit 144, a communicating unit 145, a drive 146, and a removable storage medium 147 which are connected to one another via a bus 148 and the AI model developer terminal 121 is capable of transmitting and receiving data and programs.

The control unit 141 is constituted of a processor and a memory and controls overall operations of the AI model developer terminal 121. In addition, the control unit 141 includes a mining processing unit 151 and a verification processing unit 152.

The mining processing unit 151 executes development processing of an AI model as mining processing that is considered necessary for distributed consensus formation of a blockchain.

More specifically, the mining processing unit 151 acquires various kinds of information related to an AI model development request and presents the acquired information to the AI model developer.

When the AI model developer is about to accept the development request for an AI model based on the presentation, the mining processing unit 151 accesses the blockchain 201 (FIG. 12) in accordance with contents of an operation by the AI model developer.

When the mining processing unit 151 accesses the blockchain 201 (FIG. 12), the mining processing unit 151 acquires a software simulator considered necessary for development of the AI model or information such as various kinds of source codes considered necessary for development based on various kinds of information related to the AI model development request that are recorded as the smart contract 252 (FIG. 12).

The mining processing unit 151 executes development processing of an AI model for realizing the task solution as mining processing using the acquired software simulator considered necessary for development of the AI model and information such as various kinds of source codes considered necessary for the development.

When the mining processing unit 151 is able to realize the task accomplishment first among the AI model developer terminals 121-1 to 121-n by the development processing of the AI model as mining processing, the mining processing unit 151 adds a new block 221 (FIG. 12) and extends the blockchain 201 (FIG. 12).

In addition, the mining processing unit 151 broadcasts information indicating that the task accomplishment has been realized and information related to the developed AI model to the other AI model developer terminals 121-2 to 121-n using the smart contract 252.

When an AI model realizing task accomplishment is developed and information on the developed AI model is broadcasted by another AI model developer terminal 121, the verification processing unit 152 executes verification processing based on the broadcasted information on the AI model.

In addition, the verification processing unit 152 verifies whether the task accomplishment has been realized, and when it can be verified that the task accomplishment is realized, the verification processing unit 152 adds the new block 221 (FIG. 12) and extends the blockchain 201 (FIG. 12).

The input unit 142 is constituted of an input device such as a keyboard, a mouse, or a touch panel used by a user such as an AI model developer to input operation commands and supplies various kinds of input signals to the control unit 141.

The output unit 143 is controlled by the control unit 141 and includes a display unit and a sound output unit. The output unit 143 outputs and displays an operation screen and images of processing results on the display unit constituted of a display device constituted of an LCD (Liquid Crystal Display), an organic EL (Electro Luminescence), or the like. In addition, the output unit 143 controls the sound output unit constituted of a sound output device and reproduces various kinds of sounds, music, sound effects, and the like.

The storage unit 144 is constituted of an HDD (Hard Disk Drive), an SSD (Solid State Drive), a semiconductor memory, or the like that is controlled by the control unit 141 and writes or reads various kinds of data and programs.

The communicating unit 145 is controlled by the control unit 141 and realizes communication represented by a LAN (Local Area Network), Bluetooth (registered trademark), or the like by wired or wireless means and transmits and receives various kinds of data and programs to and from various apparatuses via the network 120 as necessary.

The drive 146 writes and reads data to and from the removable storage medium 147 that is a magnetic disk (including a flexible disk), an optical disk (including a CD-ROM (Compact Disc-Read Only Memory) or a DVD (Digital Versatile Disc)), a magneto-optical disk (including an MD (Mini Disc)), a semiconductor memory, or the like.

### <Example of Configuration of AI Model Development Requestor Terminal>

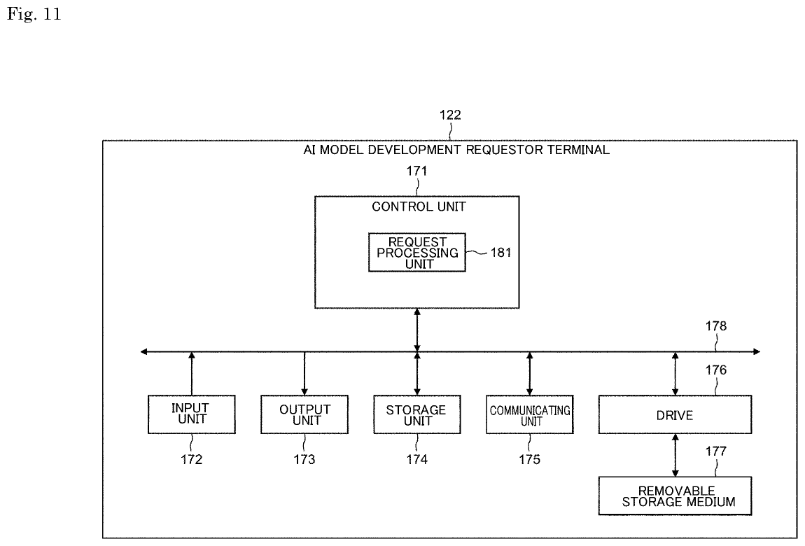

Next, a configuration example of the AI model development requestor terminal 122 will be described with reference to FIG. 11.

The AI model development requestor terminal 122 is constituted of a control unit 171, an input unit 172, an output unit 173, a storage unit 174, a communicating unit 175, a drive 176, and a removable storage medium 177 which are connected to one another via a bus 178 and the AI model development requestor terminal 122 is capable of transmitting and receiving data and programs.

Since the control unit 171, the input unit 172, the output unit 173, the storage unit 174, the communicating unit 175, the drive 176, the removable storage medium 177, and the bus 178 are components corresponding to the control unit 141, the input unit 142, the output unit 143, the storage unit 144, the communicating unit 145, the drive 146, the removable storage medium 147, and the bus 148 mutually shown in FIG. 10, detailed descriptions will be omitted.

The control unit 171 includes a request processing unit 181. The request processing unit 181 uploads various kinds of information related to an AI model development request to an AI model developer's website or a public site such as an SNS being managed by the AI model developer site management server 123.

The request processing unit 181 uploads information such as various software simulators and various source codes required for the development of the AI model of which development is to be requested to a source code management site or an image data management site managed by the management site management server 124.

The request processing unit 181 records, in each block 221 (FIG. 12) of the blockchain 201 (FIG. 12), an AI model of which development is to be requested, a development task, an environment, a condition for accomplishment, and a reward that can be acquired when the task is accomplished by the development, or a URL of the AI model developer site management server 123 to which the pieces of information are uploaded, and a software simulator considered necessary for development of the AI model of which development is to be requested and information such as various kinds of source codes considered necessary for development, or information on a URL of the management site management server 124 to which the pieces of information are uploaded as the smart contract 252 (FIG. 12), and presents the smart contract 252 to the AI model developer terminal 121.

In addition, when there is a broadcast indicating task accomplishment from any of the AI model developer terminals 121, the request processing unit 181 executes verification processing in a similar manner to the other AI model developer terminals 121 and accepts extension of a block when the task has been appropriately accomplished.

### <Example of Structure of Blockchain According to Present Disclosure>

Next, a structure example of the blockchain according to the present disclosure will be described with reference to FIG. 12. The blockchain 201 shown in FIG. 12 is structured such that n-number of blocks from block 221-1 to block 221-n are linked together as if they were a chain. Hereinafter, when there is no need to distinguish among blocks 221-1 to 221-n, the blocks shall simply be referred to as a block 221, and other components shall be referred to in a similar manner.

Each block 221 includes a hash value 250 from a previous block, information on a node ID and earned virtual currency (node ID+earned virtual currency) 251, the smart contract 252, digital data 253, and an AI model development request hash value 254.

The hash value 250 from a previous block is a component corresponding to the hash value 70 (FIG. 1) from the previous block and is a hash value supplied from the immediately preceding block 221 when the block 221 constituting the blockchain 201 is added.

The information on a node ID and earned virtual currency 251 is information on a node ID identifying the AI model developer terminal 121 that is a node having realized distributed consensus formation constituted of Proof of Work and having succeeded in developing an AI model realizing task accomplishment by so-called mining when the block 221 that constitutes the blockchain 201 is added and information on virtual currency that is acquired as a reward for the node being the first to develop the AI model that satisfies a predetermined condition through mining processing.

The smart contract 252 is a component corresponding to the smart contract 72 (FIG. 1) and is a program to carry out contractual matters for handling the blockchain 31. While one smart contract 252 is drawn in the diagram, a plurality of smart contracts 252 exist depending on the transaction. In addition, development requests and various kinds of information related to development requests, information on task accomplishment, and other information related to the development of the AI model that is mining processing are described in the smart contract 252.

More specifically, when the development of an AI model is requested, a node ID identifying the AI model development requestor terminal 122 having requested the development and information on a request destination node condition that limits the AI model developer terminal 121 to be a request destination having been recorded by the AI model development requestor terminal 122 are recorded in a transaction in the block 221 as the smart contract 252.

In addition, an AI model of which development is to be requested, a development task, an environment (a tool considered necessary for development), a condition for accomplishment, and information on an amount of a reward that can be acquired when the task is accomplished by the development, or a URL of the AI model developer site management server 123 to which the pieces of information are uploaded having been recorded by the AI model development requestor terminal 122 are recorded in a transaction in the block 221 as the smart contract 252.

Furthermore, a software simulator considered necessary for development of the AI model of which development is to be requested and information such as various kinds of source codes considered necessary for the development or a URL of the management site management server 124 to which the pieces of information are uploaded are recorded in a transaction in the block 221 as the smart contract 252.

In addition, when a development task of the AI model of which development was requested is accomplished, a hash value of the smart contract 252 of the request source, a node ID specifying the AI model developer terminal 121 of the AI model developer, a hash value of information specifying the AI model having accomplished the task (for example, a setting value of the AI model or parameters of the AI model), and information of a URL to which task accomplishment is to be reported are recorded in a transaction in the block 221 as the smart contract 252 and broadcasted to other AI model developer terminals 121.

Furthermore, when a software simulator considered necessary for development of the AI model recorded in the smart contract 252 to be a request source is executed in the AI model developer terminal 121 at a developed setting value and the accomplishment of the development task is verified and confirmed, the development task accomplishment is recorded in a transaction in the block 221 as the smart contract 252, the block 221 is added, and the blockchain 201 is extended.

While digital data 253 is data of which integrity is to be managed and is generally data constituted of one or two or more transactions or the like, the digital data 253 is not limited thereto and may be an image, a video, a blueprint, music, a text, software, an AI model, or other digital works of which integrity is to be managed. While an example in which one piece of digital data 253 is stored in the block 221 is shown in the drawing, there may be a plurality of pieces of digital data 253.

The AI model development request hash value 254 is a hash value that specifies a task of an AI model having succeeded in distributed consensus formation constituted of Proof of Work or, in other words, an AI model having realized task accomplishment.

In the present disclosure, a new block 221 is added when distributed consensus formation is made according to Proof of Work, the AI model developer terminals 121 being a plurality of nodes connected to a P2P network develop an AI model requested by the AI model development requestor terminal 122, and information on an AI model having solved a predetermined development task first is verified to realize task accomplishment by another AI model developer terminal 121 being another node.

At this point, the AI model developer terminal 121 (a user thereof) that is the node having developed the AI model satisfying a predetermined condition first acquires a reward.

The processing of developing an AI model that accomplishes the development task may be, for example, a process of finding a setting value that accomplishes the development task while changing a weight setting value in a round-robin manner when the AI model is constituted of a neural network. In the case of such processing, since processing by the AI model is to be repeated while changing the setting value and results in processing that solves the task in that a success rate increases in accordance with computational power, the higher the performance of the AI model developer terminal 121 that is a node, the higher the likelihood of early detection.

In this case, in the present disclosure, the processing of developing a setting value of an AI model that accomplishes the development task is so-called mining processing.

### <Example of Development of AI Model>

Next, a development example of an AI model that is mining processing in the present specification will be described.

In the present specification, processing of obtaining a setting value of weight of a hidden layer for improving image quality of an image to be reconstructed so as to exceed a predetermined image quality when a reconstruction unit in a lensless imaging apparatus is to be realized by an AI model constituted of a neural network will be considered as a development example of an AI model.

It is assumed that the weight of the hidden layer in the reconstruction unit constituted of a neural network can be controlled by a setting value. Therefore, in this case, the mining processing is processing of searching for a setting value of the AI model that realizes task accomplishment.

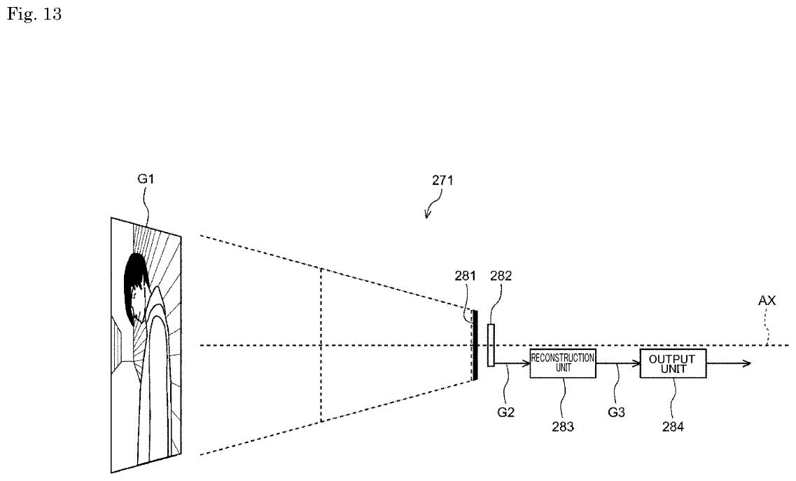

Next, an outline of the lensless imaging apparatus will be described with reference to FIG. 13. FIG. 13 is a side sectional view of an imaging apparatus 271.

The imaging apparatus 271 shown in FIG. 13 is a so-called lensless imaging apparatus and includes a mask 281, an imaging element 282, a reconstruction unit 283, and an output unit 284.

The mask 281 is a plate-like component made of a light-shielding material provided in front of the imaging element 282, and is constituted of, for example, a transmission area made of hole-shaped openings that allow incident light to pass through and a light-shielding area that is a shielded area other than the transmission area.

When the mask 281 receives light from a subject plane (in reality, a plane from which light emitted from a three-dimensional subject is emitted) G1 indicated by an optical axis AX as incident light, the mask 281 subjects the incident light from the subject plane G1 as a whole to modulation by transmitting the incident light through the transmission area and converts the incident light into modulated light, and causes the imaging element 282 to receive and capture the converted modulated light.

The imaging element 282 includes a CMOS (Complementary Metal Oxide Semiconductor) image sensor or a CCD (Charge Coupled Device) image sensor, and captures an image of modulated light obtained by modulating the incident light from the subject plane G1 using the mask 281, and outputs the resulting image as a modulated signal G2 on a pixel-by-pixel basis to the reconstruction unit 283. More specifically, the imaging element 282 includes a signal processing unit (not illustrated), generates RAW data based on an image constituted of the modulated signal G2, and outputs the RAW data to the reconstruction unit 283.

The mask 281 is large enough to include at least an entire surface of the imaging element 282 and is basically configured so that only modulated light having been modulated by transmission through the mask 281 is received by the imaging element 282.

In addition, the transmission area constructed in the mask 281 is at least larger than a pixel size of the imaging element 282. Furthermore, a gap of a small distance d is provided between the imaging element 282 and the mask 281.

### <Imaging Processing of Lensless Imaging Apparatus>

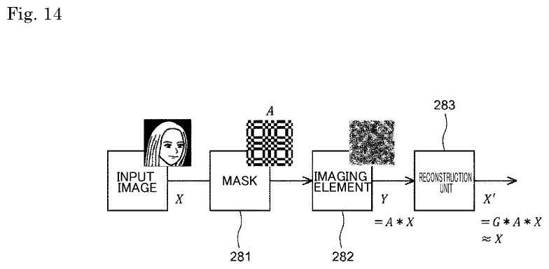

The imaging apparatus 271 that is realized according to the principle described above captures images through processing shown in FIG. 14.

In other words, incident light constituted of an input image X corresponding to the subject plane G1 shown in FIG. 13 is incident to the mask 281, modulated by a pattern A of the mask 281, and captured by the imaging element 282.

The imaging element 282 captures the incident light obtained by modulating the input image X corresponding to the subject plane G1 by the pattern A of the mask 281 as a modulated image Y that corresponds to the modulated signal G2 in FIG. 13 and outputs the modulated image Y to the reconstruction unit 283.

The reconstruction unit 283 reconstructs a final image X′ corresponding to the input image X corresponding to the final image G3 in FIG. 13 by subjecting the modulated image Y to signal processing.

In a series of processing of the imaging apparatus 271, the modulated image Y corresponding to the modulated signal G2 captured by the imaging element 282 is known to be expressible as a convolution of the pattern A of the mask 281 and the input image X as shown in the following equation (1).

Y=A*X (1)

In the equation, as shown in FIG. 14, Y denotes a modulated image captured by the imaging element 282, A denotes a matrix representing the pattern of the mask 281, X denotes an input image, and * denotes a convolutional operation.

General examples of patterns of the mask 281 that can be represented as the matrix A include a URA (Uniformly Redundant Arrays) pattern and a MURA (Modified URA) pattern P2.

It is known that the autocorrelation function of each of the URA pattern and the MURA pattern is a 8 function. By utilizing this feature, image reconstruction processing can be performed through convolution as represented in the following Equation (2), which makes it possible to perform a lightweight calculation through a FFT (Fast Fourier Transform).

X′=G*A*X=F⁻¹(F(G)·F(A*X)) (2)

In the equation, X′ represents a reconstructed image corresponding to the reconstructed image G3 in FIG. 13 and G represents a restoration matrix (inverse matrix of A) that corresponds to the matrix of the pattern A of the mask 281.

The present disclosure is assumed to adopt a configuration in which the processing performed by the reconstruction unit 283 and constituted of a determinant expressed by G*A in equation (2) is realized by an AI model constituted of a neural network.

In addition, processing of finding setting values of a weight and a pattern that make an image quality of a reconstructed image X′ that is reconstructed from the modulated image Y higher than a predetermined image quality by varying a weight in a hidden layer of the neural network that constitutes the AI model that functions as the reconstruction unit 283 as a setting value is assumed to be development processing of an AI model or, in other words, mining processing.

Therefore, when the reconstruction unit 283 is realized by an AI model constituted of a neural network, a development task of an AI model in this case is to find a setting value that specifies a weight in a hidden layer of the neural network constituting the reconstruction unit 283 capable of making an image quality of a reconstructed image X′ that is reconstructed on the basis of the modulated image Y generated by the input image X and the mask 281 by an optical simulation that realizes an operation simulating the AI model higher than a predetermined image quality.

In this case, a development requestor of an AI model uses the AI model development requestor terminal 122 to upload a software optical simulator which realizes an operation simulating the AI model to be developed and which converts the input image X into a reconstructed image X′ in accordance with a setting value and outputs the reconstructed image X′ and information indicating that a tool for computing an evaluation index by comparing the input image X and the reconstructed image X′ and the like are being distributed to the AI model developer site management server 123, which manages an AI model developer Website or a public site such as an SNS, in advance.

In addition, the development requestor of an AI model provides an environment necessary for the development of the AI model by using the AI model development requestor terminal 122 to upload, as the environment necessary for the development of the AI model, a software optical simulator which realizes an operation simulating the AI model to be developed and which converts the input image X into a reconstructed image X′ in accordance with a setting value and outputs the reconstructed image X′, a source code of an evaluation index computing tool that computes an evaluation index by comparing the input image X and the reconstructed image X′, and the like to the management site management server 124.

Furthermore, the development requestor of an AI model uses the AI model development requestor terminal 122 to set, for example, a target evaluation index required by an evaluation index calculation tool that executes an image quality evaluation of an image to be reconstructed as an accomplishment condition of a task and uploads the target evaluation index to the management site management server 124.

In addition, when a condition for a reward is that the task is accomplished such that the evaluation value obtained by the evaluation index calculation tool that executes an image quality evaluation of an image to be reconstructed exceeds a target evaluation value, the development requestor of an AI model uses the AI model development requestor terminal 122 to present a condition of the reward that can be earned.

Furthermore, the development requestor of an AI model uses the AI model development requestor terminal 122 to record, in the smart contract 252 in the blockchain 201, a URL where information on the development task, the software optical simulator necessary for development, and a source code of the evaluation index calculation tool that executes image quality evaluation of an image to be reconstructed by comparing the input image X with the reconstructed image X′ are stored, a condition of task accomplishment, and a condition of a reward as described above.

<Distributed Consensus Formation of Blockchain when Development Processing of AI Model is Mining Processing>

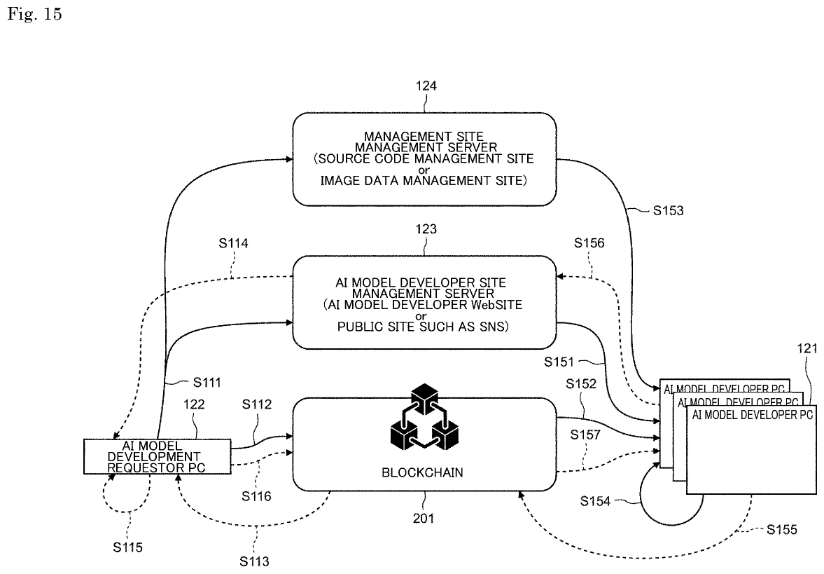

Next, a flow of processing of realizing a distributed consensus formation of a blockchain when development processing of an AI model by the information processing system 111 shown in FIG. 9 is considered mining processing will be described with reference to FIG. 15.

In step S111, the request processing unit 181 of the AI model development requestor terminal 122 uploads an AI model of which development is to be requested, a development task, an environment, a condition for accomplishment, and information on a reward that can be acquired when the development task is accomplished to an AI model developer's website or a public site such as an SNS being managed by the AI model developer site management server 123.

In addition, the AI model development requestor terminal 122 uploads information such as various software optical simulators considered necessary for development of the AI model of which development is to be requested and various source codes considered necessary for development to a source code management site or an image data management site managed by the management site management server 124.

In step S112, the request processing unit 181 records a URL where information on the development task, the software optical simulator necessary for development, and a source code of the evaluation index calculation tool that executes image quality evaluation of an image to be reconstructed by comparing the input image X with the reconstructed image X′ are stored, a condition of task accomplishment, and a condition of a reward as the smart contract 252 in a transaction of the block 221 in the blockchain 201.

In step S151, the mining processing unit 151 of the AI model developer terminal 121 accesses an AI model developer's website or a public site such as an SNS being managed by the AI model developer site management server 123 and presents the existence of a development request for an AI model to an AI model developer who is a user.

Accordingly, when contents of the request for development is to be confirmed by the AI model developer, a corresponding operation is input and processing of step S152 is performed.

In step S152, the mining processing unit 151 accesses the blockchain 201 and presents, to the AI model developer who is a user, a URL where information on the development task, the software optical simulator necessary for development, and a source code of the evaluation index calculation tool that executes image quality evaluation of an image to be reconstructed by comparing the input image X with the reconstructed image X′ are stored, a condition of task accomplishment, and a condition of a reward which are recorded as the smart contract 252 in a transaction.

Accordingly, when an AI model is to be developed by the AI model developer having accepted the request for development, a corresponding operation is input and processing of step S153 is performed.

In step S153, in accordance with the information at the URL where the software optical simulator necessary for development and the source code of the evaluation index calculation tool that executes image quality evaluation of an image to be reconstructed which are recorded as the smart contract 252 are stored, the mining processing unit 151 accesses a source code management site or an image data management site being operated by the management site management server 124 and acquires the software optical simulator necessary for development and the source code of the evaluation index calculation tool or the like.

In step S154, the mining processing unit 151 executes mining processing, reconstructs the reconstructed image by executing the software optical simulator while changing a setting value, and repeats the development processing of an AI model to obtain an image quality evaluation of the reconstructed image by the evaluation index calculation tool until the condition for task accomplishment is satisfied.

Once the task accomplishment is realized, the processing advances to step S155.

In step S155, the mining processing unit 151 presents and broadcasts, as the smart contract 252 in a transaction in a new block 221 of the blockchain 201, the fact that the task has been solved, a node ID of the AI model developer terminal 121 having realized the task accomplishment, a hash value of a setting value at the time of task accomplishment (a setting value of the AI model is not yet public at this time point), and a URL where the setting value of the AI model having realized the task accomplishment is scheduled to be published.

In step S113, the request processing unit 181 acquires, based on the smart contract 252 in a transaction in the new block 221 of the blockchain 201, the fact that the task has been solved, a node ID of the AI model developer terminal 121 having realized the task accomplishment, a hash value of a setting value at the time of task accomplishment (the setting value is not yet public at this time point), and a URL where the setting value of the AI model having realized the task accomplishment is scheduled to be published and recognizes that the task has been solved.

In step S156, after sufficient time has elapsed for the distribution of the new block 221 due to the broadcast indicating the task accomplishment, the mining processing unit 151 accesses an AI model developer's website or a public site such as an SNS being managed by the AI model developer site management server 123 and uploads and publishes the setting value of the AI model having accomplished the task.

In step S114, the request processing unit 181 accesses an AI model developer's website or a public site such as an SNS being managed by the AI model developer site management server 123 and downloads and acquires the setting value of the AI model having accomplished the task.

In step S115, the request processing unit 181 reconstructs a reconstructed image by controlling the software optical simulator recorded in the smart contract 252 at the acquired setting value of the AI model having accomplished the task and uses the evaluation index calculation tool to verify that the evaluation index of the reconstructed image has accomplished the task.

When the task accomplishment is verified, in step S116, the request processing unit 181 connects a new block and extends the blockchain 201.

As shown in step S157, the AI model developer terminal 121 not having been able to realize the task accomplishment reconstructs a reconstructed image after a notification of task accomplishment is issued by controlling the software optical simulator recorded in the smart contract 252 at the acquired setting value of the AI model having accomplished the task and uses the evaluation index calculation tool to verify that the evaluation index of the reconstructed image has accomplished the task, and when task accomplishment is verified, connects a new block 221 and extends the blockchain 201.

As described above, by replacing mining processing with development processing of an AI model of searching for a setting value of the AI model that realizes task accomplishment while changing the setting value, the mining processing can be made into processing that enhances productivity.

As a result, high-cost computation processing related to the mining processing can be effectively utilized.

In addition, since a development request of an AI model, distribution of a simulator and source data necessary for the development, and payment of a reward upon task accomplishment can be realized by a smart contract, a developer of the AI model and the like can utilize processing that requires high-cost computation processing of which a success rate increases in accordance with computational power with relative ease in order to solve a task.

### <Processing of AI Model Development Requestor Terminal>

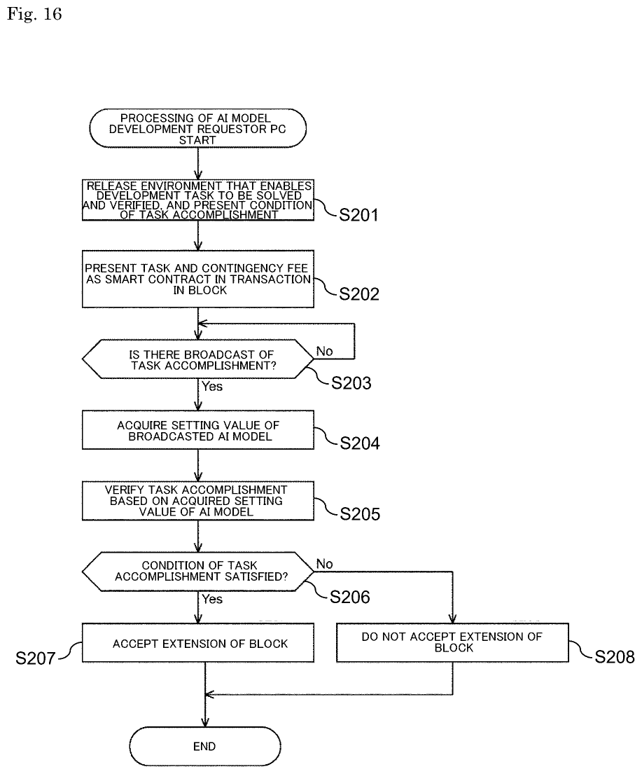

Next, processing by the AI model development requestor terminal 122 will be described with reference to the flow chart shown in FIG. 16.

In step S201, the request processing unit 181 of the AI model development requestor terminal 122 uploads and presents an AI model of which development is to be requested, a development task, an environment, a condition for accomplishment, and a reward that can be acquired when the development task is accomplished to an AI model developer's website or a public site such as an SNS being managed by the AI model developer site management server 123.

In addition, the AI model development requestor terminal 122 uploads and presents information such as various software optical simulators considered necessary for development of the AI model of which development is to be requested and various source codes considered necessary for development to a source code management site or an image data management site managed by the management site management server 124.

In step S202, the request processing unit 181 records a URL where information on the development task, the software optical simulator necessary for development, and a source code of the evaluation index calculation tool that executes image quality evaluation of an image to be reconstructed by comparing the input image X with the reconstructed image X′ are stored, a condition of task accomplishment, and a condition of a reward as the smart contract 252 in a transaction of the block 221 in the blockchain 201.

In step S203, the request processing unit 181 determines whether or not the task has been solved on the basis of the smart contract 252 in the transaction in the new block 221 of the blockchain 201 and repeats similar processing until a broadcast that the task has been solved is made.

In addition, when it is determined that a broadcast that the task has been solved is made in step S203, the processing advances to step S204.

In step S204, the request processing unit 181 accesses an AI model developer's website or a public site such as an SNS being managed by the AI model developer site management server 123 and downloads and acquires the setting value of the AI model having accomplished the task.

In step S205, the request processing unit 181 reconstructs a reconstructed image by controlling the software optical simulator recorded in the smart contract 252 at the acquired setting value of the AI model having accomplished the task and uses the evaluation index calculation tool to verify that the index of the reconstructed image has accomplished the task.

In step S206, the request processing unit 181 determines whether or not it has been verified that the acquired setting value of the AI model that accomplished the task satisfies the condition for task accomplishment and the AI model has realized the task accomplishment.

When it is determined in step S206 that it has been verified that the condition for task accomplishment has been satisfied and the AI model has realized the task accomplishment, the processing advances to step S207.

In step S207, the request processing unit 181 accepts a block extension, connects a new block, and extends the blockchain 201.

On the other hand, when it is determined in step S206 that task accomplishment has not been verified, the processing advances to step S208.

In step S208, the request processing unit 181 does not accept a block extension, does not connect a new block, and does not extend the blockchain 201.

### <Mining Processing According to Present Disclosure>

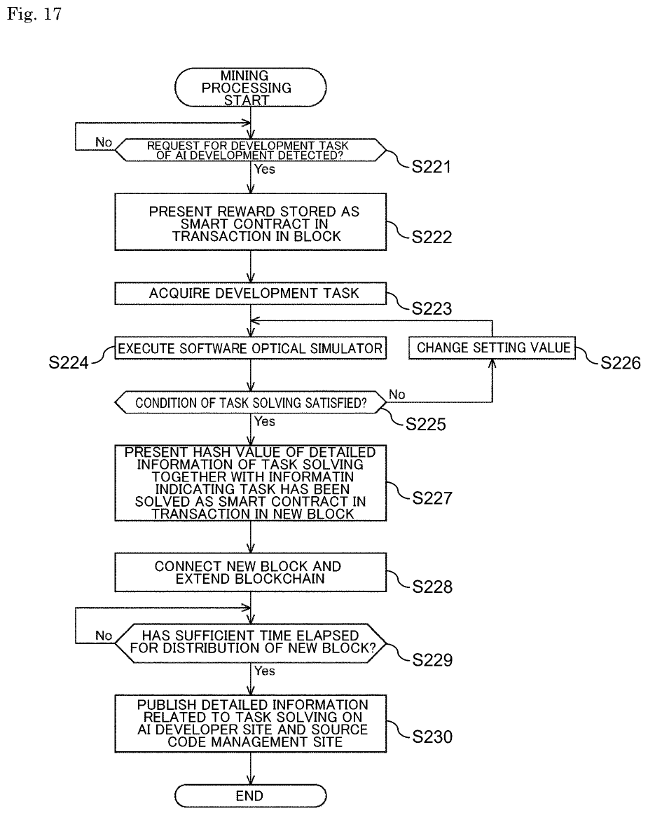

Next, mining processing by the AI model developer terminal 121 will be described with reference to the flow chart shown in FIG. 17.

In step S221, the mining processing unit 151 of the AI model developer terminal 121 accesses an AI model developer's website or a public site such as an SNS being managed by the AI model developer site management server 123 and determines whether or not a development request for an AI model exists, and repeats similar processing until the development request is deemed to exist.

When it is determined in step S221 that a development request for an AI model exists, the processing advances to step S222.

In step S222, the mining processing unit 151 accesses the blockchain 201 and presents, to the AI model developer who is a user, a URL where information on the development task, the software optical simulator necessary for development, and a source code of the evaluation index calculation tool that executes image quality evaluation of an image to be reconstructed by comparing the input image X with the reconstructed image X′ are stored, a condition of task accomplishment, and a condition of a reward which are recorded as the smart contract 252 of a transaction.

Accordingly, when an AI model developer is to accept a request for development, a corresponding operation is input and processing of step S223 is performed.

In step S223, in accordance with the information at the URL where the software optical simulator necessary for development and the source code of the evaluation index calculation tool that executes image quality evaluation of an image to be reconstructed are recorded as the smart contract 252 are stored, the mining processing unit 151 accesses a source code management site or an image data management site being operated by the management site management server 124 and acquires the software optical simulator necessary for development and the source code of the evaluation index calculation tool or the like.

In step S224, the mining processing unit 151 drives the software optical simulator with a predetermined setting value and reconstructs a reconstructed image.

In step S225, the mining processing unit 151 obtains an evaluation index of the image quality of the reconstructed image with the evaluation index calculation tool and determines whether or not the condition of task accomplishment is satisfied.

When it is determined in step S225 that the condition of task accomplishment is not satisfied, the processing advances to step S226 to change the setting value in predetermined units, and the processing returns to step S224.

In other words, processing of reconstructing the reconstructed image using the software optical simulator while changing a setting value and calculating the evaluation index of the reconstructed image using the evaluation index calculation tool is repeated until task accomplishment is realized.

In addition, when task accomplishment is realized in step S225, the processing advances to step S227.

In step S227, the mining processing unit 151 presents and broadcasts, as the smart contract 252 in a transaction in a new block 221 of the blockchain 201, the fact that the task has been solved, a node ID of the AI model developer terminal 121 having realized the task accomplishment, a hash value of a setting value at the time of task accomplishment (the setting value is not yet public at this time point), and a URL where the setting value of the AI model having realized the task accomplishment is scheduled to be published.

In step S228, the mining processing unit 151 adds a new block 221 and extends the blockchain 201. In doing so, a reward for obtaining the setting value of the AI model having realized task accomplishment first is acquired.

In step S229, the mining processing unit 151 determines whether or not sufficient time has elapsed for the distribution of the new block and repeats similar processing until it is deemed that sufficient time has elapsed for the distribution of the new block.

In addition, when sufficient time has elapsed for the distribution of the new block in step S229, the processing advances to step S230.

In step S230, the mining processing unit 151 accesses an AI model developer's website or a public site such as an SNS being managed by the AI model developer site management server 123 and uploads and publishes the setting value of the AI model having accomplished the task.

### <Verification Processing According to Present Disclosure>

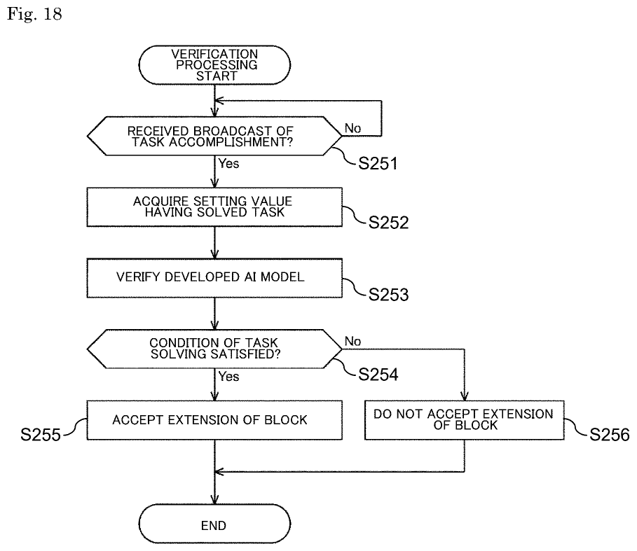

Next, verification processing by the AI model developer terminal 121 will be described with reference to the flow chart shown in FIG. 18.

In step S251, the verification processing unit 152 determines whether or not the task has been solved on the basis of the smart contract 252 in the transaction in the new block 221 of the blockchain 201 and repeats similar processing until a broadcast that the task has been solved is made.

In addition, when it is determined that a broadcast that the task has been solved is made in step S251, the processing advances to step S252.

In step S252, the verification processing unit 152 accesses an AI model developer's website or a public site such as an SNS being managed by the AI model developer site management server 123 and downloads and acquires the setting value of the AI model having accomplished the task.

In step S253, the verification processing unit 152 reconstructs a reconstructed image by controlling the software optical simulator recorded in the smart contract 252 at the acquired setting value of the AI model having accomplished the task, obtains an evaluation index of the reconstructed image using the evaluation index calculation tool, and verifies that the evaluation index is higher than a target evaluation index and has accomplished the task.

In step S254, the verification processing unit 152 determines whether or not it has been verified that the condition for task accomplishment has been satisfied by the acquired setting value of the AI model having accomplished the task and the AI model has realized the task accomplishment.

When it is determined in step S254 that it has been verified that the condition for task accomplishment has been satisfied and the AI model has realized the task accomplishment, the processing advances to step S255.

In step S255, the verification processing unit 152 accepts a block extension, connects a new block, and extends the blockchain 201.

On the other hand, when it is determined in step S254 that it has been verified that the condition for task accomplishment has not been satisfied and the AI model has not realized the task accomplishment, the processing advances to step S256.

In step S256, the verification processing unit 152 does not accept a block extension, does not connect a new block, and does not extend the blockchain 201.

As described above, by replacing mining processing with development processing of an AI model of obtaining an evaluation index while changing a setting value of an AI model and searching for a setting value which realizes task accomplishment and which is higher than a target evaluation index due to the series of processing described above, the mining processing can be made into processing of high productivity.

As a result, a processing result of mining processing can be effectively utilized and the effective utilization of the processing result enables cost-effectiveness with respect to resources and power consumption related to the mining processing to be improved.

In addition, since a development request of an AI model, distribution of a simulator and source data necessary for the development, and payment of a reward upon task accomplishment can be realized by a smart contract, a task such as the development of an AI model can be requested with relative ease.

While an example of a blockchain in which mining processing is made development processing of an AI model and a new block is extended and a reward is acquired when a task is accomplished has been described above, the mining processing is not limited to the development processing of an AI model.

For example, mining processing may be processing of obtaining a data set of which an evaluation index increases when a specific AI model is used.

### <Application Examples of Blockchain>

The blockchain may be configured so that a new block is added and a reward can be acquired by, for example, processing of training or evaluating an AI model, processing of editing, utilizing, or evaluating a data set, processing of discovering a data set capable of attacking an AI model, or processing of obtaining a special value or statistics from a simulation result that requires a round-robin evaluation.

In addition, for example, a block may be added and temporary or permanent access to a predetermined AI model or data set may be given as a reward in virtual currency when task accomplishment is realized or when requested work is completed.

Furthermore, a block may be added and a reward may be given when a large number of nodes are requested to perform a large number of tasks involving recognition, classification, or the like and the request is fulfilled.

A block may be added and virtual currency may be given as a reward when a task such as a development, an evaluation, or the like of an AI model is requested to a specific node and the task is completed.

In addition, a reward may be allowed to fluctuate by allowing experience of a predetermined node in developing, training, or evaluating AI models to be stored as history in a smart contract or the like so that such experience can be proved.

Furthermore, with respect to work requests, a history of development and the like may be recorded in a smart contract or the like so that a reward fluctuates according to a most recent reward or the like based on the history.

In addition, a given task may be requested to a plurality of nodes by being parallelized or divided and, upon completion of the task, a block may be extended and a reward may be distributed to the plurality of nodes.

Furthermore, a verification operation, a fraud detection operation, or an alternative operation with respect to a result of work requested as mining processing may be managed.

### <Variation of Mining>

While an example in which mining processing is processing of developing an AI model capable of task accomplishment in realizing distributed consensus formation through Proof of Work has been described above, the mining processing may be other processing.

The mining processing may be a deep learning-related computational work that takes time to search but readily verified such as processing of searching for a specific AI model including processing of searching for an AI model that can perform a more ideal modification when a pre-modified image and an ideal modified image are given and processing of searching for an AI model that can perform a more ideal recognition when images, audio, and an ideal recognition result are given.

In addition, the mining processing may be processing of searching for a specific data set including processing of searching for an input data set of which evaluations are most dispersed or evaluations are most consistent with respect to a plurality of AI models with the same function and processing of searching for an input data set of which an evaluation is highest, most dispersed, lowest, or closest to a median or a mean with respect to an AI model.

Furthermore, the mining processing may be processing of obtaining a special value or statistics in a simulation result that requires a round-robin evaluation such as a shared computation of a highly-random physical simulation.

In addition, the mining processing may be processing of conducting a tournament involving a plurality of AI models with respect to a predetermined data set, processing of inputting a plurality of data sets to a given AI model and selecting a data set with a most characteristic output, or processing that combines or repeats these kinds of processing or processing of conducting a repechage.

Furthermore, the mining processing may involve a plurality of nodes working together and sharing a result (a mining pool method).

In addition, the mining processing may be combined with conventional processing of obtaining a specific hash value by a hash function such as SHA-256 or may be combined with Proof of Stake.

### <Variation of Smart Contract>

While the smart contract according to the present disclosure has been described as an example of realizing processing of requesting development of an AI model, processing of distributing information necessary for the development, processing of distributing information on an AI model having realized task accomplishment, and processing of distributing rewards, other processing may also be performed.

For example, a smart contract may allow a transaction to be concluded when a condition is satisfied or a consortium-based smart contract may be adopted so that a value with respect to a need is controlled (partially centralized control) according to a population of nodes belonging to the consortium.

In addition, a smart contract may also be used to control a range of application of privacy due to shrink-wrapping an SLA (Service Level Agreement) that simultaneously confirms a privacy-related agreement, training data, and the use of an AI model, adding mosaic to an image, or the presence or absence of meta information. In this case, the range of application of privacy may be controlled by leveling according to a security level of an applicable product and a user's agreement.

### 3. Application Examples

### <Business Development of AI Models and Data Sets>

An example of effectively utilizing a result of processing with a high processing load due to the enormous resources involved in mining processing by making the mining processing related to distributed consensus formation when adding the block 221 of the blockchain 201 highly productive processing such as processing of searching for an AI model or a data set that satisfies a predetermined condition has been described above.

A configuration may be adopted in which, due to the processing described above, an AI model or a data set generated by mining processing is registered in a marketplace and an incentive is paid to a developer having developed the AI model or the data set by mining processing when the AI model or the data set is downloaded.

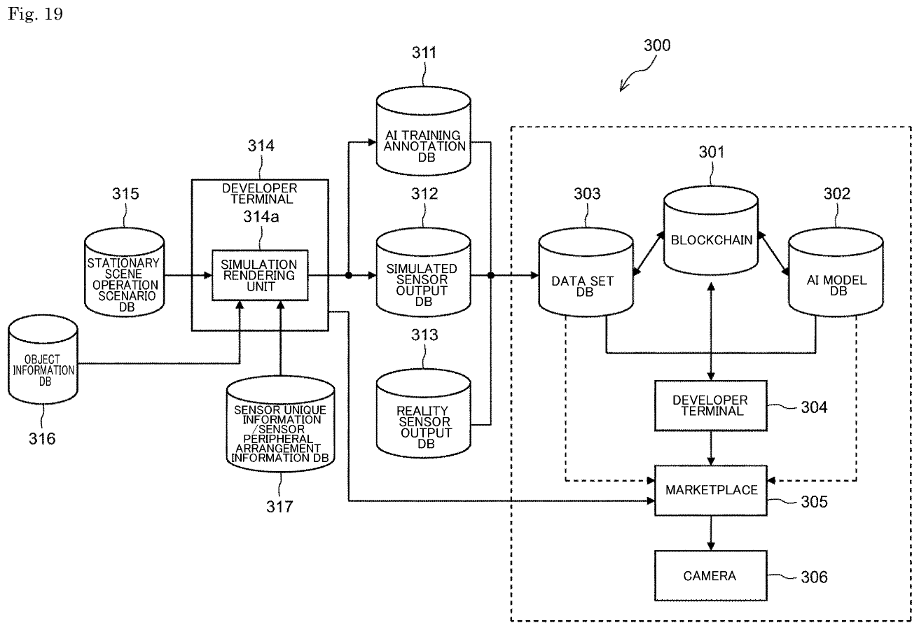

FIG. 19 is a diagram showing an outline of an information processing system in which an AI model or a data set generated by mining processing is registered in a marketplace and an incentive is paid to a developer having developed the AI model or the data set by mining processing when the AI model or the data set is downloaded.

An information processing system 300 shown in FIG. 19 is basically constituted of a blockchain 301, an AI model DB (Database) 302, a data set DB 303, a developer terminal 304, a marketplace 305, and a camera 306 which are enclosed by a dotted line in the drawing.

In this case, the blockchain 301 and the developer terminal 304 are components that correspond to the blockchain 201 and the AI model developer terminal 121 described above.

The AI model DB (Databese) 302 is a database in which AI models searched by the mining processing described above are accumulated. In the AI model DB (Databese) 302, AI applications developed using the accumulated AI models may also be accumulated in association with the AI models.

The data set DB 303 is a database in which data sets for training of the AI models searched by the mining processing described above are accumulated.

While it is assumed that the AI models and the data sets are intended for image recognition processing of images captured by the camera 306 for the sake of simplicity of description, the AI models and the data sets may be intended for other processing.

The developer terminal 304 develops an AI model and a data set through the mining processing described above which is performed to add a block to the blockchain 301 and registers the AI model and the data set in the AI model DB 302 and the data set DB 303.

The marketplace (electronic marketplace) 305 is a mechanism for realizing electronic commerce enabled by cloud computing and allows the purchase of registered AI models or registered data sets by registering personal information.

In this case, a developer operates the developer terminal 304 and registers an AI model or a data set developed by the developer by mining processing. In the drawing, the AI model DB 302 and the data set DB 303 are connected by a dotted line by the marketplace 305 to represent the fact that AI models and data sets respectively accumulated in the DBs are registered in the marketplace 305.

Higher recognition accuracy can be provided with respect to such AI models and data sets registered for the objective of image recognition processing by installing the AI models and the data sets on, for example, the camera 306 with an image recognition function through the marketplace 305.

When AI models and data sets are sequentially developed and updated by the developer terminal 304, image recognition processing can be further improved by purchasing a new AI model and data set via the marketplace 305 and re-installing the purchased AI model and data set.

Furthermore, by developing a data set in accordance with a characteristic and an installation position of the camera 306, an AI model can be retrained according to the characteristic and the installation position of the camera 306.

In FIG. 19, a configuration is adopted in which a data set including unique information of the camera 306 is registered in the data set DB 303 when the developer terminal 314 is operated by the developer who develops the data set.

In other words, the developer terminal 314 operated by the developer who develops a data set includes a simulation rendering unit 314a and generates a dedicated data set in accordance with unique characteristics and installation situation of the camera 306 by executing simulation rendering.

More specifically, the simulation rendering unit 314a respectively reads sensor unique information and sensor peripheral arrangement information specific to the camera 306 from a database 317, information on an object to be recognized from a database 316, and a stationary scene operation scenario to be recognized from a database 315, executes simulation rendering, generates an annotation for AI training and a simulated sensor output based on a reproduced video as a result of executing the simulation rendering, and respectively registers the annotation for AI training and the simulated sensor output in an AI training annotation DB 311 and a simulated sensor output DB 312. The reproduced video as a result of executing the simulation rendering is not limited to a live-action video and may be a combination of capturing and reproducing actual motion using CG (Computer Graphics) in a VR (Virtual Reality) space or a metaverse or a combination of a physical simulation and an AI simulation. For example, a video recreating a traffic accident between a car and a person in the rain may be reproduced by simulation rendering that combines the plurality of techniques described above.

In addition, an image actually captured by the camera 306 is registered in a reality sensor output DB 313 as a reality sensor output.

Furthermore, data sets to which the annotation for AI training, the simulated sensor output, and the reality sensor output are respectively associated with respect to the camera 306 are stored in the data set DB 303.

A data set unique to the camera 306 which is generated by the developer terminal 314 may also be developed as mining processing when extending a block of the blockchain 301 or may be developed separately.

In addition, the developer having developed a data set unique to the camera 306 using the developer terminal 314 may register the developed data set to the marketplace 305 so that an incentive is obtained when the data set is downloaded.

By registering a data set unique to the camera 306 to the marketplace 305 in this manner, for example, the camera 306 (a user thereof) equipped with an image recognition function can purchase a new data set unique to the camera 306 via the marketplace 305 and use the purchased data set to retrain an AI model, and using the retrained AI model enables image recognition accuracy to be improved.

### <Overall Configuration of System>

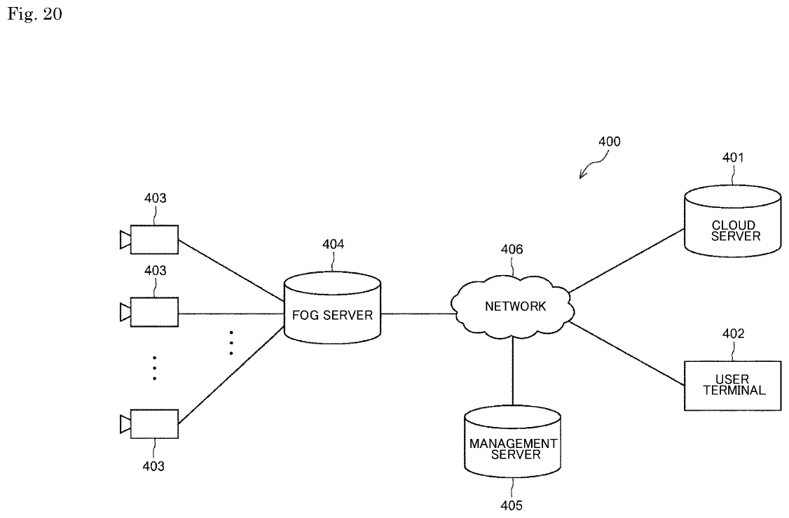

FIG. 20 is a block diagram showing a schematic configuration example of an information processing system 400 as an embodiment according to an application example of the present disclosure.

As illustrated, the information processing system 400 includes at least a cloud server 401, a user terminal 402, a plurality of cameras 403, a fog server 404, and a management server 405. In the present example, at least the cloud server 401, the user terminal 402, the fog server 404, and the management server 405 are configured to be capable of performing mutual communication via a network 406 being the Internet or the like.

The cloud server 401, the user terminal 402, the fog server 404, and the management server 405 are configured as information processing apparatuses equipped with a microcomputer including a CPU (Central Processing Unit), a ROM (Read Only Memory), and a RAM (Random Access Memory).

In this case, the user terminal 402 is an information processing apparatus that is expected to be used by a user being a recipient of a service using the information processing system 400. In addition, the management server 405 is an information processing apparatus that is expected to be used by a provider of the service.

Each camera 403 is a component that corresponds to the camera 306 shown in FIG. 19 including, for example, an image sensor such as a CCD (Charge Coupled Device)-type image sensor or a CMOS (Complementary Metal Oxide Semiconductor)-type image sensor, captures an image of a subject, and obtains image data (captured image data) as digital data.

In addition, as will be described later, each camera 403 also includes a function of performing processing (for example, image recognition processing and image detection processing) using an AI (Artificial Intelligence) with respect to a captured image. In the following description, various kinds of processing with respect to images such as image recognition processing and image detection processing will be simply described as “image processing”. For example, various kinds of processing with respect to images using an AI (or an AI model) will be described as “AI image processing”.

Each camera 403 is configured to be capable of performing data communication with the fog server 404 and, for example, capable of transmitting various kinds of data such as processing result information indicating a result of processing (such as image processing) using an AI to the fog server 404 and receiving various kinds of data from the fog server 404.

In this case, for example, conceivable applications of the information processing system 400 shown in FIG. 20 include having the fog server 404 or the cloud server 401 generate analysis information of a subject based on processing result information obtained by image processing of each camera 403 and having the user view the generated analysis information via the user terminal 402.

In this case, conceivable applications of each camera 403 include a use as various kinds of surveillance cameras. Examples of such applications include an indoor surveillance camera at a store, an office, a residence, or the like, a surveillance camera (including a traffic surveillance camera) for monitoring outdoors at a parking lot, on the street, or the like, a surveillance camera of a production line in FA (Factory Automation) or IA (Industrial Automation), and a surveillance camera that monitors inside or outside of a vehicle.

For example, in the application as a surveillance camera at a store, conceivably, a plurality of cameras 403 are respectively arranged at predetermined positions inside of the store in order to enable the user to check demographics (gender, age group, and the like), actions (flow lines) in the store, and the like of customers. In this case, information on the demographics of the customers, information on the flow lines of the customers in the store, information on a state of congestion at checkout registers (for example, a wait time at the checkout registers), or the like is conceivably generated as the analysis information described above.

Alternatively, in the application as a traffic surveillance camera, conceivably, each camera 403 is arranged at each roadside position in order to enable the user to recognize a license plate (vehicle number), a body color, a make and model, or the like of passing vehicles and, in this case, information on the license plate, the body color, the make and model, or the like of the vehicle is conceivably generated as the analysis information described above.

In addition, when a traffic surveillance camera is used at a parking lot, conceivably, the camera 403 is arranged so that each parked vehicle can be monitored to monitor whether or not a suspicious person acting suspiciously is present around each vehicle and, when there is a suspicious person, a notification of the presence of the suspicious person or attributes (gender or age group) of the suspicious person is issued.

Furthermore, also conceivably, available spaces in town or in a parking lot may be monitored to notify a user of spaces where a vehicle can be parked.

For example, in the application as a surveillance camera at a store described above, the fog server 404 is conceivably arranged for each object of surveillance together with each camera 403 such as being arranged inside of the store that is an object of surveillance. Providing the fog server 404 for each object of surveillance such as a store eliminates the need of the cloud server 401 to directly receive transmission data from the plurality of cameras 403 at the objects of surveillance and a reduction in processing load on the cloud server 401 can be achieved.

When there are a plurality of stores to be objects of surveillance and all of the stores belong to the same chain of stores, one fog server 404 may conceivably be provided for the plurality of stores instead of providing one fog server 404 per store. In other words, the fog server 404 is not limited to providing one fog server 404 per object of surveillance but it is also possible to provide one fog server 404 for a plurality of objects of surveillance.

When the function of the fog server 404 can be included in the cloud server 401 or each camera 403 due to the cloud server 401 or each camera 403 having processing capability or the like, the fog server 404 may be omitted in the information processing system 400, each camera 403 may be directly connected to the network 406, and the cloud server 401 may directly receive transmission data from the plurality of cameras 403.

In the following description, the various kinds of apparatuses described above can be broadly classified into cloud-side information processing apparatuses and edge-side information processing apparatuses.

The cloud-side information processing apparatuses include the cloud server 401 and the management server 405 and are a group of apparatuses that provide a service expected to be used by a plurality of users.

In addition, the edge-side information processing apparatuses include the cameras 403 and the fog server 404 and can be comprehended as a group of apparatuses that are arranged inside of an environment provided by a user using a cloud service.

However, both cloud-side information processing apparatuses and edge-side information processing apparatuses may be present in an environment provided by the same user.

Note that the fog server 404 may be an on-premise server.

### <Registration of AI Model and AI Application>

As described above, in the information processing system 400, AI image processing is performed by the camera 403 that is an edge-side information processing apparatus and sophisticated application functions are realized in the cloud server 401 that is a cloud-side information processing apparatus using information on a result of edge-side AI image processing (for example, information on a result of image recognition processing using an AI).

In this case, there are various possible methods of registering an application function in the cloud server 401 (or including the fog server 404) that is a cloud-side information processing apparatus.

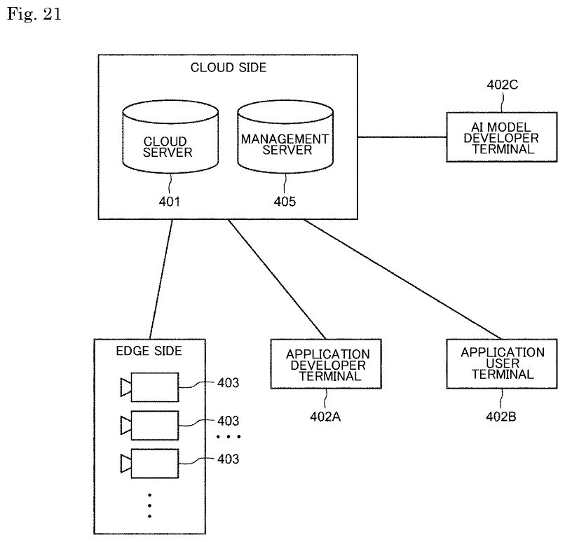

One example will be described with reference to FIG. 21.

While the fog server 404 is not illustrated in FIG. 21, a configuration including the fog server 404 may be adopted instead. In doing so, the fog server 404 may be made responsible for providing a part of edge-side functions.

The cloud server 401 and the management server 405 described above are information processing apparatuses that constitute a cloud-side environment.

In addition, the camera 403 is an information processing apparatus that constitutes an edge-side environment.

The camera 403 can be comprehended as an apparatus including a control unit that performs overall control of the camera 403 or the camera 403 can be comprehended as an apparatus including another apparatus as an image sensor IS including a computation processing unit that performs various kinds of processing including AI image processing with respect to a captured image. In other words, the image sensor IS that is an edge-side information processing apparatus may be comprehended as being mounted inside of the camera 403 that is another edge-side information processing apparatus.

In addition, examples of the user terminal 402 used by a user to use various kinds of services provided by the cloud-side information processing apparatuses include an application developer terminal 402A used by a user to develop an application to be used in AI image processing, an application user terminal 402B used by a user to use an application, and an AI model developer terminal 402C used by a user to develop an AI model to be used in AI image processing. The application user terminal 402B and the AI model developer terminal 402C are components corresponding to the developer terminals 304 and 314 shown in FIG. 19.

Obviously, the application developer terminal 402A may be used by a user to develop an application that does not use AI image processing.

A training data set for training by an AI is prepared for the cloud-side information processing apparatus. The user to develop an AI model communicates with the cloud-side information processing apparatus using the AI model developer terminal 402C and downloads the training data set.

In this case, the training data set may be provided for a fee. For example, the AI model developer may purchase the training data set in a state where various kinds of functions and materials registered in a marketplace (electronic marketplace) that is prepared as a cloud-side function can be purchased by registering personal information in the marketplace. The marketplace in this case corresponds to the marketplace 305 shown in FIG. 19.

After developing an AI model using the training data set, the AI model developer uses the AI model developer terminal 402C to register the developed AI model in the marketplace. Accordingly, an incentive may be paid to the AI model developer when the AI model is downloaded.

In addition, the AI model developer may use the AI model developer terminal 121 in the information processing system 111 shown in FIG. 9 to register an AI model generated by mining processing in the marketplace and an incentive may be paid to the AI model developer when the AI model is downloaded.

Furthermore, in addition to an AI model, a data set generated by mining processing may be registered in the marketplace and an incentive may be paid to a developer having developed the data set by mining processing when the data set is downloaded.

In addition, a user to develop an application uses the application developer terminal 402A to download an AI model from the marketplace and develops an application (hereinafter, described as an “AI application”) using the AI model. At this point, an incentive may be paid to the AI model developer as described earlier.

An application-developing user uses the application developer terminal 402A to register the developed AI application in the marketplace. Accordingly, an incentive may be paid to the user having developed the AI application when the AI application is downloaded.

A user to use the AI application uses the application user terminal 402B to perform an operation for deploying the AI application and an AI model from the marketplace to the camera 403 as an edge-side information processing apparatus that is managed by the user. At this point, an incentive may be paid to the AI model developer.

Accordingly, the camera 403 becomes capable of performing AI image processing using an AI application and an AI model and can detect customers and vehicles by the AI image processing in addition to capturing images.

In this case, deploying an AI application and an AI model means that the AI application and the AI model are installed in an object (apparatus) as an executing entity so that the object as an executing entity can use the AI application and the AI model or, in other words, the object as an executing entity can execute at least a part of the programs as the AI application.

In addition, in the camera 403, AI image processing may enable attribute information of a customer to be extracted from a captured image taken by the camera 403.

The attribute information is transmitted from the camera 403 to the cloud-side information processing apparatuses via the network 406.

Cloud applications are deployed on the cloud-side information processing apparatuses and each user can use the cloud applications via the network 406.

The cloud applications include a prepared application for analyzing a flow line of a customer using attribute information and a captured image of the customer. Such cloud applications are uploaded by the application-developing user or the like.

By using the cloud application for flow line analysis using the application user terminal 402B, an application-using user can perform a flow line analysis of a customer visiting the user's own store and view an analysis result. The analysis result is viewed by, for example, graphically presenting the flow line of the customer on a map of the store.

Alternatively, the result of the flow line analysis may be displayed in the form of a heat map and the analysis result may be viewed by presenting a density of customers or the like.

In addition, the information may be sorted for display by customer attribute information.

An AI model optimized for each user may be registered in the cloud-side marketplace. For example, captured images taken by the camera 403 arranged in a store managed by a given user are appropriately uploaded to and accumulated in a cloud-side information processing apparatus.

In the cloud-side information processing apparatus, retraining processing of an AI model is performed every time a certain number of uploaded captured images are accumulated and processing of updating the AI model and re-registering the AI model in the marketplace is executed.

For example, the retraining processing of an AI model may be made selectable as an option for users on the marketplace.

For example, by deploying an AI model having been retrained using dark images from the camera 403 located in a store to the camera 403, a recognition rate and the like of image processing with respect to captured images taken in dark locations can be improved. In addition, by deploying an AI model having been retrained using bright images from the camera 403 located outside of a store to the camera 403, a recognition rate and the like of image processing with respect to captured images taken in bright locations can be improved.

In other words, the application-using user can always obtain optimized processing result information by re-deploying an updated AI model in the camera 403.

In addition, when information (such as a captured image) uploaded from the camera 403 to a cloud-side information processing apparatus contains personal information, data from which privacy-related information has been removed from the viewpoint of privacy protection may be uploaded or data from which privacy-related information has been removed may be made available to AI model-developing users and application developing users.

### <Outline of Functions of System>

In the present embodiment, a service that enables a user as a customer to select a type of function with respect to AI image processing of each camera 403 is envisaged as a service using the information processing system 400.

The selection of a type of function may involve, for example, selecting the image recognition function, the image detection function, and the like or selecting even finer types of functions so that the image recognition function and the image detection function with respect to a specific subject are exhibited.

For example, as a business model, a service provider sells the cameras 403 and the fog servers 404 including an AI-based image recognition function to a user and the user installs the cameras 403 and the fog servers 404 at locations to be objects of surveillance. In addition, a service that provides the user with analysis information as described above is deployed.

In this case, since different customers require different applications from the system such as an application for store surveillance and an application for traffic surveillance, the AI image processing functions included in the camera 403 are made selectively settable so that analysis information corresponding to the application required by the customer is obtained.

In the present example, a function for selectively setting the AI image processing functions of the camera 403 is included in the management server 405.

The function of the management server 405 may be included in the cloud server 401 or the fog server 404.

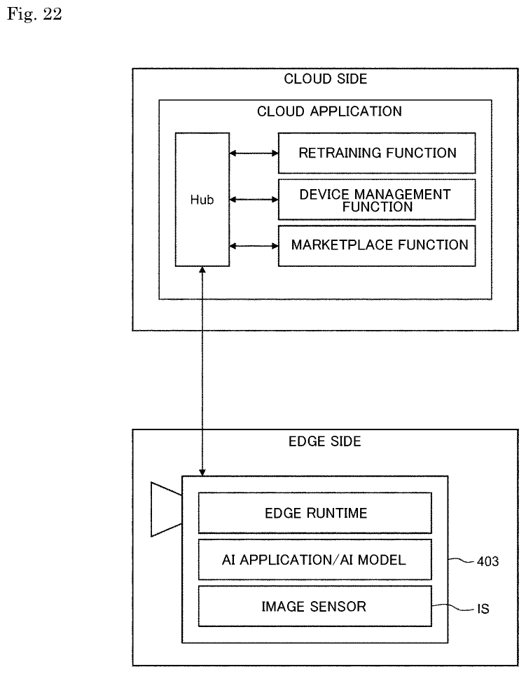

A connection between the cloud server 401 or the management server 405 that is a cloud-side information processing apparatus and the camera 403 that is an edge-side information processing apparatus will now be described with reference to FIG. 22.

The cloud-side information processing apparatus is mounted with a retraining function, a device management function, and a marketplace function that are functions usable via a Hub.

The Hub performs highly secure and reliable communication to the edge-side information processing apparatus. Accordingly, various kinds of functions can be provided to the edge-side information processing apparatus.

The retraining function is a function of performing retraining and providing a newly optimized AI model and, accordingly, an appropriate AI model based on new training material is provided.

The device management function is a function of managing the camera 403 or the like as the edge-side information processing apparatus and, for example, functions such as managing and monitoring the AI model deployed in the camera 403 and detecting or troubleshooting problems can be provided.

In addition, the device management function is also a function of managing information of the camera 403 and the fog server 404. The information of the camera 403 and the fog server 404 include information on a chip used as a computation processing unit, information on a memory capacity, a storage capacity, and CPU and memory utilization, and information on software such as an OS (Operating System) installed in each apparatus.

Furthermore, the device management function protects secure access by authenticated users.

The marketplace function provides a function of registering an AI model developed by the AI model developer described above (including an AI model and a data set generated by mining processing) and an AI application developed by an AI application developer, a function of deploying the developed articles in a permitted edge-side information processing apparatus, and the like. In addition, the marketplace function also provides a function regarding payment of an incentive in accordance with the deployment of the developed articles.

The camera 403 as the edge-side information processing apparatus includes an edge runtime, an AI application, an AI model, and the image sensor IS.

The edge runtime functions as embedded software or the like for managing an application deployed in the camera 403 and communicating with a cloud-side information processing apparatus.

The AI model refers to a deployment in the cloud-side information processing apparatus of the AI model registered in the marketplace as described above and, accordingly, the camera 403 can use a captured image to obtain result information of AI image processing suitable for its objective.

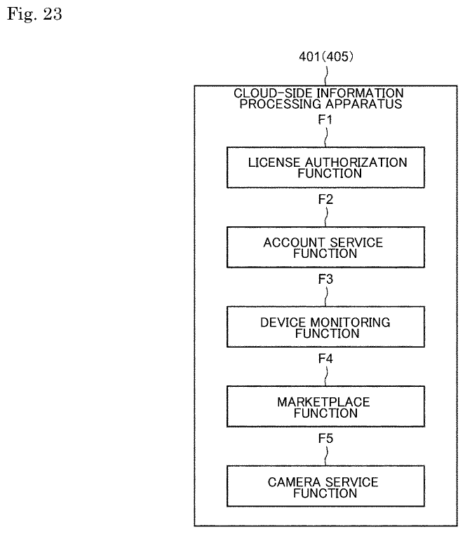

An outline of functions included in the cloud-side information processing apparatus will now be described with reference to FIG. 23. Note that the cloud-side information processing apparatus is a collective designation for apparatuses such as the cloud server 401 and the management server 405.

As illustrated, the cloud-side information processing apparatus includes a license authorization function F1, an account service function F2, a device monitoring function F3, a marketplace function F4, and a camera service function F5.

The license authorization function F1 is a function of performing processing related to various kinds of authentication. Specifically, in the license authorization function F1, processing related to device authentication of each camera 403 and processing related to authentication with respect to each AI model, software, and firmware used in the camera 403 are performed.

In this case, the software described above refers to software necessary for appropriately realizing AI image processing in the camera 403.

In order to ensure that AI image processing based on a captured image is appropriately performed and that a result of the AI image processing is transmitted to the fog server 404 or the cloud server 401 in an appropriate format, control of data input to an AI model and appropriate processing of output data of the AI model are required.

The software described above is software including peripheral processing necessary for appropriately realizing AI image processing. Such software is software for realizing a desired function using an AI model and corresponds to the AI application described above.

AI applications are not limited to those that use only one AI model and AI applications that use two or more AI models are also conceivable. For example, there may be AI applications that have a flow of processing in which information of a recognition result (such as image data and hereinafter described as “recognition result information”) obtained by an AI model that executes AI image processing using a captured image as input data is input to a different AI model to have the different AI model execute second AI image processing.

In the license authorization function F1, with respect to authentication of the cameras 403, processing of issuing a device ID (Identification) for each camera 403 is performed when the camera 403 is connected via the network 406.

In addition, with respect to authentication of an AI model or software, processing of respectively issuing a unique ID (AI model ID and software ID) is performed with respect to AI models and AI applications of which a request for registration has been issued from the AI model developer terminal 402C or the application developer terminal 402A.

In addition, in the license authorization function F1, processing of issuing various keys, certificates, and the like to enable secure communication to be performed among the camera 403, the AI model developer terminal 402C, the application developer terminal 402A, and the cloud server 401 to the manufacturer of the camera 403 (especially the manufacturer of the image sensor IS to be described below), the AI model developer, and the software developer is performed and, at the same time, processing of renewing or suspending certificate efficacy is also performed.

Furthermore, in the license authorization function F1, when user registration (registration of account information accompanying issuance of a user ID) is performed by the account service function F2 to be described below, processing of linking the camera 403 (the device ID described above) purchased by the user and the user ID to each other is also performed.

The account service function F2 is a function of generating and managing account information of a user. In the account service function F2, input of user information is accepted and account information is generated on the basis of the input user information (generation of account information including at least a user ID and password information is performed).

In addition, in the account service function F2, registration processing (registration of account information) with respect to an AI model developer or a developer of an AI application (hereinafter, also abbreviated as software developer) is also performed.

The device monitoring function F3 is a function of performing processing for monitoring a state of use of the camera 403. For example, monitoring is performed with respect to information such as a location of use of the camera 403, an output frequency of output data of AI image processing, free CPU and memory space or the like used for AI image processing, and the CPU and memory utilization as described above as various factors pertaining to the state of use the camera 403.

The marketplace function F4 is a function for selling an AI model or an AI application. For example, a user can purchase an AI application, an AI model used by the AI application, and a data set for developing an AI model via a sales website provided by the marketplace function F4. In addition, a software developer can purchase an AI model to create an AI application via the sales site described above.

The camera service function F5 is a function for providing a user with a service related to the use of the camera 403.

One of the functions of the camera service function F5 can be, for example, a function of generating the analysis information described earlier. In other words, the function is for performing processing of generating analysis information of a subject based on processing result information of image processing in the camera 403 and having the user view the generated analysis information via the user terminal 402.

In addition, the camera service function F5 includes an imaging setting search function. Specifically, the imaging setting search function is a function of acquiring recognition result information of AI image processing from the camera 403 and searching for imaging setting information of the camera 403 using an AI based on the acquired recognition result information.

In this case, imaging setting information broadly refers to setting information related to an imaging operation for obtaining a captured image. Specifically, imaging setting information broadly includes an optical setting such as a focus and an aperture, a setting related to a read operation of a captured image signal such as a frame rate, an exposure time, and a gain, and a setting related to image signal processing with respect to a read captured image signal such as gamma correction processing, noise reduction processing, and super-resolution processing.

Furthermore, the camera service function F5 also includes an AI model search function. The AI model search function is a function of acquiring recognition result information of AI image processing from the camera 403 and searching, using an AI, for an optimum AI model to be used in AI image processing in the camera 403 based on the acquired recognition result information. The search for an AI model in this case refers to, for example, when AI image processing is realized by a CNN (Convolutional Neural Network) or the like that includes a convolutional operation, processing of optimizing various processing parameters such as a weight coefficient, setting information (for example, including kernel size information) related to a neural network structure, and the like.

In addition, the camera service function F5 includes a processing sharing determination function. In the processing sharing determination function, when deploying an AI application in an edge-side information processing apparatus, processing of determining an apparatus that is a deployment destination in SW component units is performed as the deployment preparation processing described above. A part of the SW components may be determined to be executed on a cloud-side apparatus, in which case the deployment processing need not be performed as the SW components are already deployed on the cloud-side apparatus.

For example, as in the example described above, in the case of an AI application including a SW component that detects a person's face, a SW component that extracts attribute information of a person, a SW component that aggregates extraction results, and a SW component that visualizes an aggregate result, the camera service function F5 determines the image sensor IS of the camera 403 as a deployment destination apparatus with respect to the SW component that detects a person's face, determines the camera 403 as a deployment destination apparatus with respect to the SW component that extracts attribute information of a person, determines the fog server 404 as a deployment destination apparatus with respect to the SW component that aggregates the extraction results, and determines to execute the SW component that visualizes the aggregate result on the cloud server 401 instead of newly deploying the SW component to an apparatus.

In this manner, the processing sharing at each apparatus is determined by determining a deployment destination of each SW component.

The determinations are made in consideration of specifications and performance of each apparatus and requests made by the users.

By including the imaging setting search function and the AI model search function as described above, it is possible to ensure that imaging settings that produce favorable AI image processing results are configured and that AI image processing is performed using an AI model appropriate for an actual usage environment.

Including the processing sharing determination function in addition to the functions described above ensures that AI image processing and analysis processing thereof are performed by an appropriate apparatus.

Prior to deploying each SW component, the camera service function F5 includes an application setting function. The application setting function is a function of setting an appropriate AI application according to an objective of a user.

For example, an appropriate AI application is selected according to the user's selection of applications such as store surveillance or traffic surveillance. This will naturally determine the SW components that constitute the AI application.

As will be described below, there may be a plurality of combinations of SW components for achieving the user's objective using AI applications and, in this case, one combination is selected on the basis of information on the edge-side information processing device and the user's requirements.

For example, when the user's objective is store surveillance, the SW components may be combined differently if the user's requirements are privacy-oriented or speed-oriented.

In the application setting function, processing of accepting an operation by the user for selecting an objective (application) on the user terminal 402 (corresponding to the application user terminal 402B in FIG. 21), processing of selecting an appropriate AI application according to the selected application, and the like are performed.

While a configuration in which the cloud server 401 single-handedly realizes the license authorization function F1, the account service function F2, the device monitoring function F3, the marketplace function F4, and the camera service function F5 has been exemplified above, a configuration in which the functions are realized by a plurality of information processing apparatuses in a shared manner is also possible. For example, a configuration in which one information processing apparatus is responsible for each of the functions described above is conceivable. Alternatively, one of the functions described above can be shared by a plurality of information processing apparatuses (for example, the cloud server 401 and the management server 405).

In FIG. 21, the AI model developer terminal 402C is an information processing apparatus used by a developer of an AI model.

In addition, the application developer terminal 402A is an information processing apparatus used by a developer of an AI application.

### <Configuration of Imaging Apparatus>

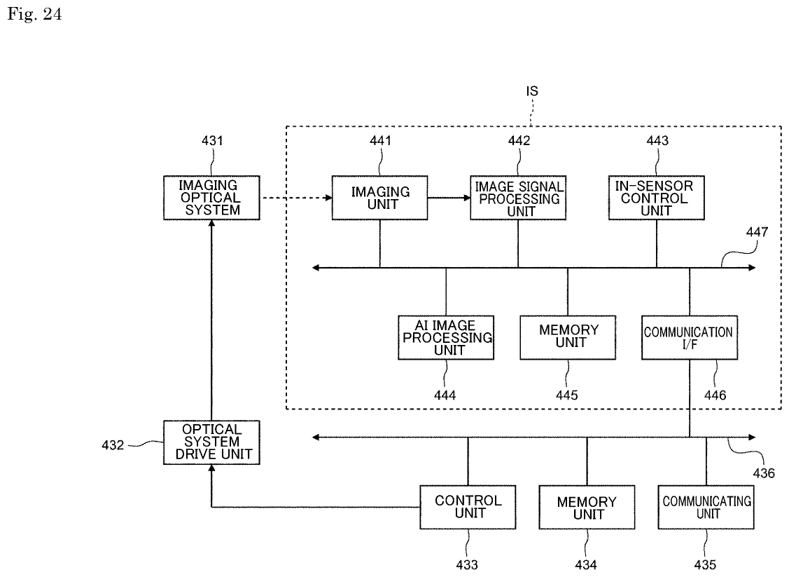

FIG. 24 is a block diagram showing an internal configuration example of the camera 403.

As illustrated, the camera 403 includes an imaging optical system 431, an optical system drive unit 432, the image sensor IS, a control unit 433, a memory unit 434, and a communicating unit 435. The image sensor IS, the control unit 433, the memory unit 434, and the communicating unit 435 are connected via a bus 36 and are capable of performing data communication with each other.

The imaging optical system 431 includes a lens such as a cover lens, a zooming lens, a focusing lens and an aperture (iris) mechanism. Due to the imaging optical system 431, light (incident light) from the subject is guided and collected on a light-receiving surface of the image sensor IS.

The optical system drive unit 432 is a comprehensive term for drive units of the zooming lens, the focusing lens, and the aperture mechanism included in the imaging optical system 431. Specifically, the optical system drive unit 432 includes actuators and drive circuits of the actuators for respectively driving the zooming lens, the focusing lens, and the aperture mechanism.

The control unit 433 is constituted of, for example, a microcomputer including a CPU, a ROM, and a RAM and controls the camera 403 as a whole as the CPU executes various types of processing according to a program stored in the ROM or a program loaded to the RAM.

In addition, the control unit 433 issues drive instructions for the zooming lens, the focusing lens, the aperture mechanism, and the like to the optical system drive unit 432. The optical system drive unit 432 is to move the focusing lens or the zooming lens, open or close aperture blades of the aperture mechanism, and the like in accordance with the drive instructions.

Furthermore, the control unit 433 performs control of reading and writing various types of data from and to the memory unit 434.

The memory unit 434 is, for example, a non-volatile storage device such as an HDD (Hard Disk Drive) or a flash memory apparatus and is used as a storage destination (recording destination) of image data output from the image sensor IS.

In addition, the control unit 433 performs various types of data communication with external apparatuses via the communicating unit 435. The communicating unit 435 according to the present example is configured to be capable of performing data communication with at least the fog server 404 (or the cloud server 401) shown in FIG. 20.

For example, the image sensor IS is configured as an image sensor such as an CCD-type image sensor or a CMOS-type image sensor.

The image sensor IS includes an imaging unit 441, an image signal processing unit 442, an in-sensor control unit 443, an AI image processing unit 444, a memory unit 445, and a communication I/F 446 and the respective components are connected via a bus 447 so as to be capable of performing data communication with each other.

The imaging unit 441 includes a pixel array portion in which pixels having photoelectric conversion elements such as photodiodes are arrayed two-dimensionally and a readout circuit that reads out electrical signals obtained by photoelectric conversion from each pixel in the pixel array portion and is capable of outputting the electric signals as captured image signals.

The readout circuit executes, for example, CDS (Correlated Double Sampling) processing, AGC (Automatic Gain Control) processing, and A/D (Analog/Digital) conversion processing with respect to electric signals obtained by photoelectric conversion.

The image signal processing unit 442 performs preprocessing, synchronization processing, YC generation processing, resolution conversion processing, codec preprocessing, and the like with respect to captured image signals as digital data after A/D conversion processing.

In preprocessing, clamping in which black levels of R, G, and B are clamped to a predetermined level, correction processing among color channels of R, G, and B, or the like is performed with respect to a captured image signal.

In synchronization processing, color separation processing in order to make image data with respect to each pixel include all of R, G, and B color components is applied. For example, in a case of an imaging element using a Bayer-pattern color filter, demosaicking is performed as the color separation processing.

In YC generation processing, a luminance (Y) signal and a color (C) signal are generated (separated) from R, G, and B image data. In resolution conversion processing, resolution conversion processing is executed with respect to image data having been subjected to various types of signal processing.

In codec processing, for example, coding processing for recording or communication and file generation are performed with respect to image data having been subjected to the various types of processing described above. In codec processing, file generation can be performed in formats such as MPEG-2 (MPEG: Moving Picture Experts Group) and H.264 as file formats of moving images.

Furthermore, conceivably, file generation can also be performed in formats such as JPEG (Joint Photographic Experts Group), TIFF (Tagged Image File Format), and GIF (Graphics Interchange Format) as still image files.

The in-sensor control unit 443 controls execution of an imaging operation by issuing an instruction to the imaging unit 441. In a similar manner, the in-sensor control unit 443 also controls execution of processing with respect to the image signal processing unit 442.

The AI image processing unit 444 performs image recognition processing as AI image processing with respect to a captured image.

Image recognition functions using an AI can be realized using, for example, a programmable computation processing unit such as a CPU, an FPGA (Field Programmable Gate Array), or a DSP (Digital Signal Processor).

The image recognition functions that can be realized by the AI image processing unit 444 can be switched by changing an algorithm of AI image processing. In other words, a function type of AI image processing can be switched by switching the AI model used for the AI image processing. While various function types of AI image processing are conceivable, examples of function types include the following.
Class identification
Semantic segmentation
Person detection
Vehicle detection
Target tracking
OCR (Optical Character Recognition)

Among the function types described above, class identification is a function of identifying a class of a target. The “class” in this case is information that represents a category of an object and distinguishes, for example, among “person”, “car”, “airplane”, “ship”, “truck”, “bird”, “cat”, “dog”, “deer”, “frog”, “horse”, and so on.

Target tracking can be described as a function that tracks a targeted subject and obtains historical information on a position of the subject.

The memory unit 445 is used as a storage destination of various kinds of data such as captured image data obtained by the image signal processing unit 442. In addition, in the present example, the memory unit 445 can also be used to temporarily store data used by the AI image processing unit 444 in the process of AI image processing.

Furthermore, the memory unit 445 stores information on an AI application and an AI model used by the AI image processing unit 444.

The information on an AI application and an AI model may be deployed in the memory unit 445 as a container or the like using containerization to be described later or using a microservices technique.

By deploying an AI model used in AI image processing in the memory unit 445, a function type of AI image processing can be changed or the AI model can be changed to an AI model of which performance has been improved through retraining.

While a description based on an example of an AI model and an AI application used in image recognition has been given in the present embodiment as described above, the present embodiment is not limited thereto and a program executed using AI technology may be addressed.

In addition, when the capacity of the memory unit 445 is small, information on an AI application and an AI model may be deployed in a memory outside of the image sensor IS such as the memory unit 434 as a container using containerization or the like and, subsequently, only the AI model may be stored in the memory unit 445 inside of the image sensor IS via the communication I/F 446 to be described below.

The communication I/F 446 is an interface that performs communication with the control unit 433, the memory unit 434, and the like outside of the image sensor IS.

The communication I/F 446 performs communication to obtain a program to be executed by the image signal processing unit 442, an AI application or an AI model to be used by the AI image processing unit 444, or the like from outside and to store the same in the memory unit 445 included in the image sensor IS.

Accordingly, the AI model is stored in a part of the memory unit 445 included in the image sensor IS and becomes usable by the AI image processing unit 444.

The AI image processing unit 444 recognizes a subject according to an objective by performing predetermined image recognition processing using the AI application or the AI model thus obtained.

Recognition result information of the AI image processing is output to outside of the image sensor IS via the communication I/F 446.

In other words, not only image data output from the image signal processing unit 442 but also recognition result information of the AI image processing is output from the communication I/F 446 of the image sensor IS.

Note that the communication I/F 446 of the image sensor IS can be configured such that only one of image data and recognition result information is output therefrom.

For example, when the retraining function of an AI model described above is to be used, captured image data used in the retraining function is uploaded from the image sensor IS to a cloud-side information processing apparatus via the communication I/F 446 and the communicating unit 435.

In addition, when inference using an AI model is to be performed, recognition result information of AI image processing is output from the image sensor IS to the camera 403 or another information processing apparatus via the communication I/F 446 and the communicating unit 435.

Various configurations of the image sensor IS are conceivable. Here, an example where the image sensor IS has a two-layer stacked structure will be described.

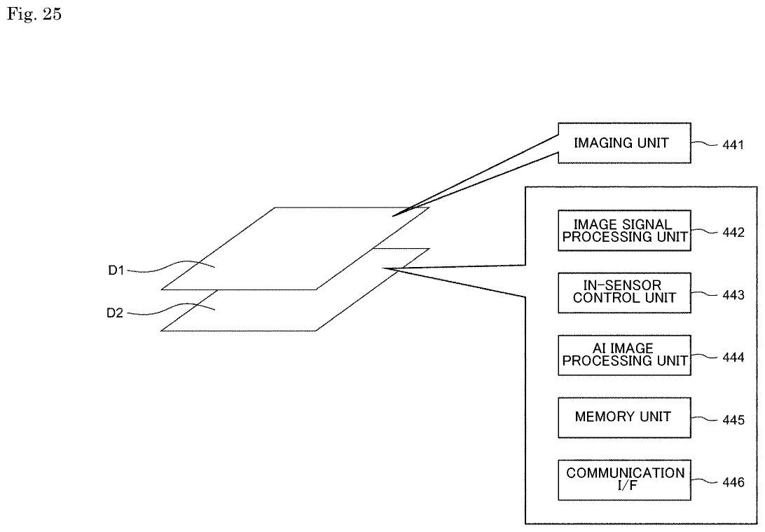

As shown in FIG. 25, the image sensor IS is configured as a single-chip semiconductor device with two dies stacked on top of each other.

The image sensor IS is configured such that a die D1 with a function as the imaging unit 441 and a die D2 including the image signal processing unit 442, the in-sensor control unit 443, the AI image processing unit 444, the memory unit 445, and the communication I/F 446, all shown in FIG. 24, are stacked on top of each other.

The die D1 and the die D2 are electrically connected by, for example, a Cu—Cu junction.

There are various conceivable ways to deploy an AI model, an AI application, and the like on the camera 403. An example using containerization will be described.

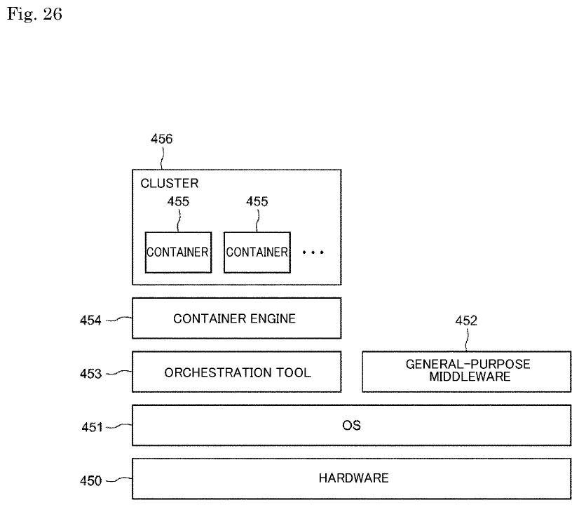

In the camera 403, an operating system 451 is installed on various pieces of hardware 450 such as a CPU, a GPU (Graphics Processing Unit), and a ROM and a RAM as the control unit 433 shown in FIG. 24 (refer to FIG. 26).

The operating system 451 is basic software that performs overall control of the camera 403 to achieve the various functions in the camera 403.

General-purpose middleware 452 is installed on the operating system 451.

The general-purpose middleware 452 is, for example, software for realizing basic operations such as a communication function using the communicating unit 435 as the hardware 450 or a display function using a display unit (such as a monitor) as the hardware 450.

In addition to the general-purpose middleware 452, an orchestration tool 453 and a container engine 454 are installed on the operating system 451.

The orchestration tool 453 and the container engine 454 deploy and execute a container 455 by constructing a cluster 456 as an operating environment of the container 455.

The edge runtime shown in FIG. 22 corresponds to the orchestration tool 453 and the container engine 454 shown in FIG. 26.

The orchestration tool 453 has a function of causing the container engine 454 to appropriately allocate resources of the hardware 450 and the operating system 451 described above. The orchestration tool 453 groups each container 455 into predetermined units (pods to be described later) and each pod is deployed to a worker node (described later) which is a logically different area.

The container engine 454 is a piece of middleware installed on the operating system 451 and is an engine that runs the container 455. Specifically, the container engine 454 has a function of allocating resources of the hardware 450 and the operating system 451 (memory, computing power, and the like) to the container 455 based on configuration files and the like provided by middleware in the container 455.

In addition, the resources allocated in the present embodiment include not only the resources included in the camera 403 such as the control unit 433 but also the resources included in the image sensor IS such as the in-sensor control unit 443, the memory unit 445, and the communication I/F 446.

The container 455 is constituted of applications and middleware such as libraries in order to achieve a predetermined function.

The container 455 operates in order to realize a predetermined function using the resources of the hardware 450 and the operating system 451 allocated by the container engine 454.

In the present embodiment, the AI application and the AI model shown in FIG. 22 correspond to one of the containers 455. In other words, one of the various containers 455 deployed in the camera 403 realizes a predetermined AI image processing function using the AI application and the AI model.

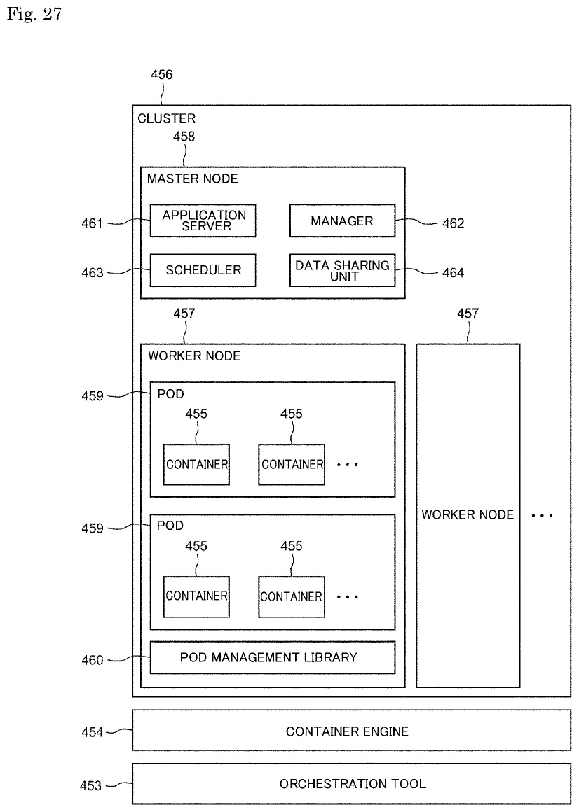

A specific configuration example of the cluster 456 constructed by the container engine 454 and the orchestration tool 453 will be described with reference to FIG. 27. The cluster 456 may be constructed across a plurality of devices so that the functionality of the cluster 456 is achieved using not only the hardware 450 included in one camera 403 but also the resources of other hardware included in other devices.

The orchestration tool 453 manages an execution environment of the container 455 on a per-worker node 457 basis. In addition, the orchestration tool 453 constructs a master node 458 that manages the entire worker node 457.

A plurality of pods 459 are deployed in the worker node 457. Each pod 459 is constituted of one or more containers 455 and realize a predetermined function. The pod 459 is considered a management unit for managing containers 455 by the orchestration tool 453.

The operation of the pods 459 in the worker node 457 is controlled by a pod management library 460.

The pod management library 460 is constituted of a container runtime that enables the pod 459 to utilize logically allocated resources of the hardware 450, an agent that accepts control from the master node 458, a network proxy for performing communication between pods 459 and communication with the master node 458, and the like.

In other words, each pod 459 is enabled by the pod management library 460 to realize a predetermined function using each resource.

The master node 458 is configured to include an application server 461 that deploys the pod 459, a manager 462 that manages a deployment status of the container 455 by the application server 461, a scheduler 463 that determines the worker node 457 where the container 455 is to be arranged, and a data sharing unit 64 that shares data.

Using the configurations shown in FIGS. 26 and 27 enables the AI application and the AI model described earlier to be deployed to the image sensor IS of the camera 403 using containerization.

As described above, the AI model may be stored in the memory unit 445 in the image sensor IS via the communication I/F 446 in FIG. 24 to execute AI image processing in the image sensor IS, or the components shown in FIGS. 26 and 27 may be deployed in the memory unit 445 and the in-sensor control unit 443 in the image sensor IS and the AI application and the AI model described earlier may be executed in the image sensor IS using containerization.

In addition, as will be described later, containerization can also be used when deploying the AI application and/or the AI model to the fog server 404 or a cloud-side information processing apparatus.

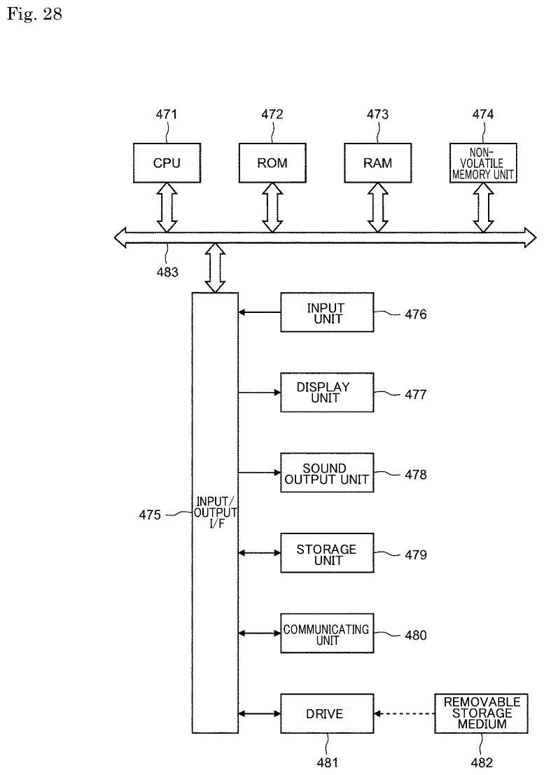

In doing so, information on the AI application or the AI model is deployed and executed as a container or the like in a memory such as a non-volatile memory unit 474, a storage unit 479, a RAM 473, or the like in FIG. 28 to be described later.

### <Hardware Configuration of Information Processing Apparatus>

A hardware configuration of information processing apparatuses such as the cloud server 401, the user terminal 402, the fog server 404, and the management server 405 included in the information processing system 400 will be described with reference to FIG. 28.

The information processing apparatus includes a CPU 471. The CPU 471 functions as a computation processing unit that performs the various kinds of processing described above and executes the various kinds of processing according to programs stored in a ROM 472 or the non-volatile memory unit 474 that is an EEP-ROM (Electrically Erasable Programmable Read-Only Memory) or the like, or programs loaded onto the RAM 473 from the storage unit 479. The RAM 473 also stores, when appropriate, data required by the CPU 471 to execute the various kinds of processing.

The CPU 471 included in an information processing apparatus as the cloud server 401 functions as a license authorizing unit, an account service providing unit, a device monitoring unit, a marketplace function providing unit, and a camera service providing unit in order to realize the respective functions described above.

The CPU 471, the ROM 472, the RAM 473, and the non-volatile memory unit 474 are connected to each other via a bus 483. An input/output interface (I/F) 475 is also connected to the bus 483.

An input unit 476 constituted of an operator or an operating device is connected to the input/output interface 475.

For example, various operators and operating devices such as a keyboard, a mouse, keys, a dial, a touch panel, a touch pad, and a remote controller are envisioned as the input unit 476.

An operation by a user is detected by the input unit 476 and a signal corresponding to the input operation is interpreted by the CPU 471.

In addition, a display unit 477 constituted of an LCD, an organic EL panel, or the like and a sound output unit 478 constituted of a speaker or the like are integrally or separately connected to the input/output interface 475.

The display unit 477 is a display unit that performs various kinds of display and is constituted of, for example, a display device provided in a housing of a computer apparatus or a separate display device connected to a computer apparatus.

The display unit 477 executes display of an image to be subjected to various types of image processing, a moving image to be processed, and the like on a display screen based on instructions of the CPU 471. In addition, the display unit 477 displays various operation menus, icons, messages, and the like or, in other words, a GUI (Graphical User Interface) based on instructions of the CPU 471.

The storage unit 479 constituted of a hard disk, a solid-state memory, or the like and a communicating unit 480 constituted of a modem or the like may be connected to the input/output interface 475.

The communicating unit 480 performs communication processing via through transmission channels such as the Internet, wired/wireless communication with various devices, bus communication, and the like.

When necessary, a drive 481 is connected to the input/output interface 475 and, when appropriate, a removable storage medium 482 that is a magnetic disk, an optical disk, a magneto optical disk, a semiconductor memory, or the like is mounted to the drive 481.

The drive 481 enables a data file and the like of a program used for each type of processing to be read from the removable storage medium 482. The read data file is stored in the storage unit 479 or an image or sound contained in the data file is output from the display unit 477 or the sound output unit 478. In addition, a computer program or the like read from the removable storage medium 482 is installed in the storage unit 479 when necessary.

In the computer apparatus, for example, software for processing according to the present embodiment can be installed via network communication by the communicating unit 480 or via the removable storage medium 482. Alternatively, the software may be stored in the ROM 472, the storage unit 479, or the like in advance.

In addition, captured images taken by the camera 403 and processing results of AI image processing may be received and stored in the removable storage medium 482 via the storage unit 479 or the drive 481.

Due to the CPU 471 performing processing operations based on various programs, information processing and communication processing necessary as the cloud server 401 that is an information processing apparatus including the computation processing unit described above are executed.

Note that the cloud server 401 is not limited to being solely constituted of a computer apparatus such as that shown in FIG. 23 and may be constituted of a system made up of a plurality of computer apparatuses. The plurality of computer apparatuses may be made into a system by a LAN (Local Area Network) or the like or arranged at remote locations by a VPN (Virtual Private Network) using the Internet or the like. The plurality of computer apparatuses may include computer apparatuses as a group of servers (cloud) that can be used by a cloud computing service.

<Flow of Processing when AI Model or AI Application is Updated>

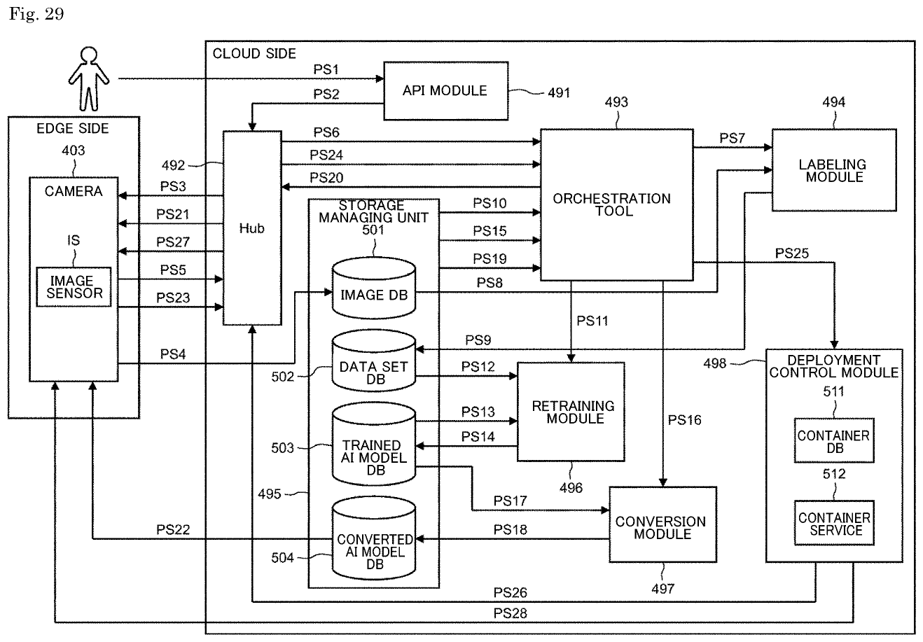

A flow of processing when, after an SW component of an AI application and an AI model are deployed, retraining of the AI model and updates of the AI model (hereinafter, “edge-side AI model”) deployed in each camera 403 or the like or the AI application are performed by being triggered by an operation by a provider or a user of a service will be described in detail with reference to FIG. 29.

Note that FIG. 29 focuses on and describes one camera 403 among the plurality of cameras 403. In addition, while the edge-side AI model to be updated in the following description is, for example, the edge-side AI model deployed in the image sensor IS included in the camera 403, it is needless to say that the edge-side AI model may be an edge-side AI model deployed outside of the image sensor IS in the camera 403.

First, in processing step PS1, a retraining instruction of an AI model is issued by a provider or a user of a service. The instruction is issued using an API (Application Programming Interface) function included in an API module 491 included in a cloud-side information processing apparatus. In addition, an amount of images (for example, the number of images) used in training is designated in the instruction. Hereinafter, the amount of images used in training will also be described as “predetermined number of images”.

The API module 491 accepts the instruction and, in processing step PS2, transmits a request for retraining and information on the amount of images to a Hub (similar to that shown in FIG. 22) 492.

In processing step PS3, the Hub 492 transmits an update notification and information on the amount of images to the camera 403 as an edge-side information processing apparatus.

In processing step PS4, the camera 403 transmits captured image data obtained by photography to an image DB (Database) 501 of a storage managing unit 495. The photography processing and the transmission processing are performed until the predetermined number of images necessary for retraining is reached.

When the camera 403 obtains an inference result by performing inference processing with respect to the captured image data, in processing step PS4, the inference result may be stored in the image DB 501 as metadata of the captured image data.

Due to the inference result in the camera 403 being stored in the image DB 501 as metadata, data required for retraining an AI model executed on the cloud side can be carefully selected.

Specifically, retraining can be performed using only image data for which the inference result in the camera 403 differs from a result of inference executed in the cloud-side information processing apparatus using ample computer resources. Therefore, time required for retraining can be reduced.

After completing photography and transmission of the predetermined number of images, in processing step PS5, the camera 403 notifies the Hub 492 that the transmission of the captured image data of the predetermined number of images has been completed.

The Hub 492 receives the notification and, in processing step PS6, notifies an orchestration tool (the same as the orchestration tool 453 shown in FIG. 26) 493 that preparation of data for retraining has been completed.

In processing step PS7, the orchestration tool 493 transmits an execution instruction of labeling processing to a labeling module 494.

The labeling module 494 acquires image data to be subjected to labeling processing from the image DB 501 (processing step PS8) and performs labeling processing.

The labeling processing referred to here may be processing of performing the class identification described above, processing of estimating the gender and age of a subject in an image and applying a label, processing of estimating a pose of the subject and applying a label, or processing of estimating behavior of the subject and applying a label.

The labeling processing may be performed manually or automatically. In addition, the labeling processing may be completed in the cloud-side information processing equipment or realized by using services provided by other server apparatuses.

The labeling module 494 having completed the labeling processing stores, in processing step PS9, result information of the labeling in a data set DB 502 (corresponding to the data set DB 303 in FIG. 19). The information stored in the data set DB 502 at this point may be a set of label information and image data or image ID (Identification) information for specifying image data instead of the image data itself.

The storage managing unit 495 having detected that result information of the labeling has been stored issues, in processing step PS10, a notification to the orchestration tool 493.

The orchestration tool 493 having received the notification confirms that labeling processing with respect to image data of the predetermined number of images has been completed and, in processing step PS11, transmits a retraining instruction to a retraining module 496.

The retraining module 496 having received the retraining instruction acquires a data set to be used in training from the data set DB 502 in processing step PS12 and acquires an AI model to be updated from a trained AI model DB 503 in processing step PS13.

The retraining module 496 uses the acquired data set and AI model to retrain the AI model. The updated AI model obtained in this manner is once again stored in processing step PS14 in the trained AI model DB 503 (corresponding to the AI model DB 302 in FIG. 19).

The storage managing unit 495 having detected that the updated AI model has been stored issues, in processing step PS15, a notification to the orchestration tool 493.

The orchestration tool 493 having received the notification transmits, in processing step PS16, a conversion instruction of an AI model to a conversion module 497.

The conversion module 497 having received the conversion instruction acquires the updated AI model from the trained AI model DB 503 in processing step PS17 and performs conversion processing of the AI model.

In the conversion processing, processing of conversion in accordance with specification information of the camera 403 being a deployment destination device or the like is performed. In the processing, downsizing is performed so as not to degrade performance of the AI model as much as possible and a file format is converted so that the AI model can run on the camera 403.

The AI model converted by the conversion module 497 is the edge-side AI model described above. The converted AI model is stored in processing step PS18 in a converted AI model DB 504.

The storage managing unit 495 having detected that the converted AI model has been stored issues, in processing step PS19, a notification to the orchestration tool 493.

The orchestration tool 493 having received the notification transmits, in processing step PS20, a notification to the Hub 492 to have the Hub 492 execute an update of the AI model. The notification includes information for specifying a location where the AI model used for the update is stored.

The Hub 492 having received the notification transmits an update instruction of the AI model to the camera 403. The update instruction also includes information for specifying a location where the AI model is stored.

In processing step PS22, the camera 403 performs processing of acquiring the converted AI model that is an object from the converted AI model DB 504 and deploying the acquired converted AI model. Accordingly, the AI model to be used by the image sensor IS of the camera 403 is updated.

The camera 403 having finished updating the AI model by deploying the AI model transmits, in processing step PS23, an update completion notification to the Hub 492.

The Hub 492 having received the notification notifies the orchestration tool 493 in processing step PS24 that the AI model update processing of the camera 403 has been completed.

While an example where an AI model is deployed and used inside the image sensor IS of the camera 403 (for example, the memory unit 445 shown in FIG. 24) has been described, an AI model can be updated in a similar manner even when the AI model is deployed and used outside the image sensor in the camera 403 (for example, the memory unit 434 in FIG. 24) or inside the fog server 404 (the storage unit 479 in FIG. 11).

In such a case, when an AI model is deployed, an apparatus (location) where the AI model is deployed is to be stored in the cloud-side storage managing unit 495 or the like, the Hub 492 reads the apparatus (location) where the AI model is deployed from the storage managing unit 495, and transmits an update instruction of the AI model to the apparatus where the AI model is deployed.

The apparatus having received the notification performs, in processing step PS22, processing of acquiring the converted AI model that is an object from the converted AI model DB 504 and deploying the acquired converted AI model. Accordingly, an update of the AI model of the apparatus having received the update instruction is performed.

When only updating the AI model, processing is completed by steps up to this point.

When updating, in addition to the AI model, an AI application using the AI model, processing described below is further executed.

Specifically, in processing step PS25, the orchestration tool 493 transmits a download instruction of an updated AI application such as firmware to a deployment control module 498.

In processing step PS26, the deployment control module 498 transmits a deployment instruction of the AI application to the Hub 492. The instruction includes information for specifying a location where the updated AI application is stored.

In processing step PS27, the Hub 492 transmits the deployment instruction to the camera 403.

In processing step PS28, the camera 403 downloads the updated AI application from a container DB 511 of the deployment control module 498 and deploys the downloaded AI application.

In the above description, an example of sequentially updating an AI model that runs on the image sensor IS of the camera 403 and updating an AI application that runs outside of the image sensor IS in the camera 403 was described.

In addition, while an AI application has been described here for the sake of simplicity of description, an AI application is defined by a plurality of SW components, when an AI application is deployed, a location where each SW component is deployed is stored in the cloud-side storage managing unit 495 or the like so that when carrying out processing step PS27, the Hub 492 is configured to read an apparatus (location) where each SW component had been deployed from the storage managing unit 495 and transmit a deployment instruction to the deployed apparatus. In processing step PS28, the apparatus having received the deployment instruction downloads the updated SW component from the container DB 511 of the deployment control module 498 and deploys the downloaded SW component.

The AI application referred to here is an SW component other than an AI model.

When both an AI model and an AI application are to run on a single apparatus, both the AI model and the AI application may be collectively updated as a single container. In such a case, an update of the AI model and an update of the AI application may occur simultaneously rather than sequentially. This can be realized by executing the processing of respective processing steps of PS25, PS26, PS27, and PS28.

For example, when it is possible to deploy containers of both an AI model and an AI application in the image sensor IS of the camera 403, the AI model and the AI application can be updated by executing the processing of respective processing steps PS25, PS26, PS27, and PS28 as described above.

By performing the processing described above, retraining of an AI model is performed using captured image data taken in a usage environment of the user. Therefore, an edge-side AI model that can output a highly-accurate recognition result in the usage environment of the user can be generated.

In addition, even if the usage environment of the user changes such when changing a layout inside a store or changing an installation location of the camera 403, since retraining of the AI model can be appropriately performed whenever such a change occurs, recognition accuracy due to an AI model can be maintained without lowering the recognition accuracy.

Each processing step described above may be executed not only when retraining an AI model but also when running the system for the first time in the usage environment of the user.

### <Screen Example of Marketplace>

An example of a screen presented to a user in relation to a marketplace will be described with reference to the drawings.

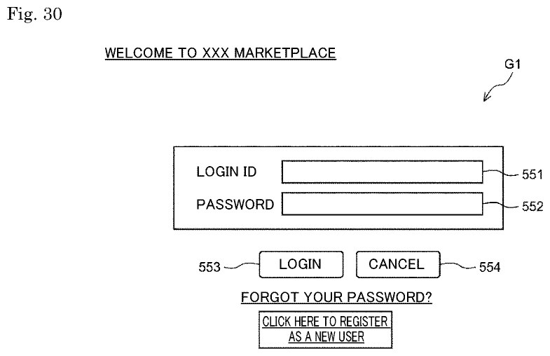

FIG. 30 shows an example of a login screen G1.

The login screen G1 is provided with an ID input field 551 for inputting a user ID and a password input field 552 for inputting a password.

A login button 553 for logging in and a cancel button 554 for canceling a login are arranged below the password input field 552.

An operator for making a transition to a page for users who had forgotten their password, an operator for making a transition to a page for registration as a new user, and the like are appropriately arranged further below.

When the login button 553 is depressed after inputting an appropriate user ID and password, processing of making a transition to a user-specific page is respectively executed on the cloud server 401 and the user terminal 402.

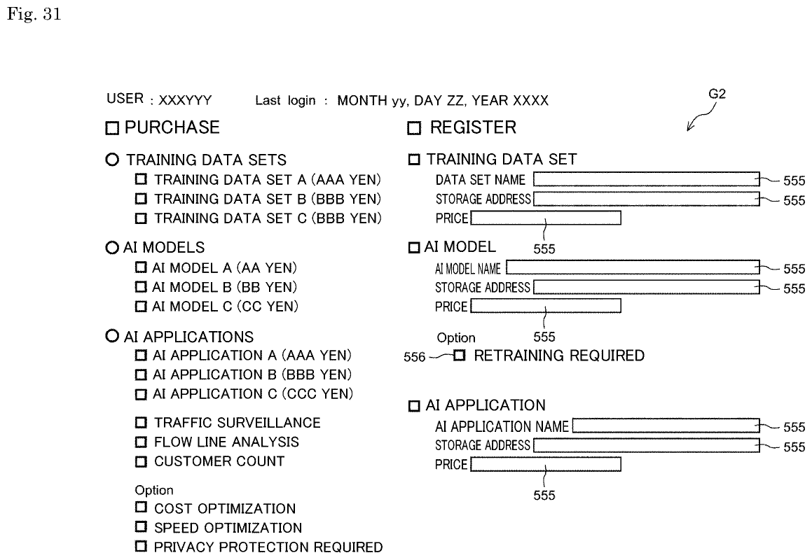

FIG. 31 is an example of a screen presented to, for example, an AI application developer who uses the application developer terminal 402A or an AI model developer who uses the AI model developer terminal 402C.

Each developer can purchase a training data set, an AI model, or an AI application for development through the marketplace. In addition, each developer can register an AI application or an AI model developed by himself/herself to the marketplace.

On a developer's screen G2 shown in FIG. 31, a training data set, an AI model, an AI application, and the like (hereinafter, collectively described as “data”) which can be purchased are displayed on a left side.

Although not illustrated, when purchasing a training data set, an image of the training data set is shown on the display, and preparations for training can be made by simply using an input apparatus such as a mouse to frame only a desired portion of an image and entering a name.

For example, when desiring to perform AI training using an image of a cat, by framing only a portion of the cat on the image and entering “cat” as a text entry, an image to which an annotation of a cat has been added can be prepared for AI training.

In addition, objectives such as “traffic surveillance”, “flow line analysis”, and “customer count” may be made selectable to make it easy to find desired data. In other words, display processing such that only data conforming to the selected objective is displayed is respectively executed on the cloud server 401 and the user terminal 402.

A purchase price of each piece of data may be displayed on the developer's screen G2.

In addition, an input 555 for registering a training data set collected or created by the developer and an AI model or an AI application developed by the developer are provided on a right side of the developer's screen G2.

The input 555 for inputting a name and a storage location of the data are provided for each piece of data. A check box 556 for setting whether or not retraining is necessary is provided with respect to each AI model.

Note that a price setting field (described as input 555 in drawing) which enables a price necessary when purchasing data to be registered to be set may be provided.

In addition, a user name, a latest login date, and the like are displayed as a part of user information in an upper part of the developer's screen G2. Furthermore, an amount of currency, the number of points available to the user, or the like when purchasing data may also be displayed.

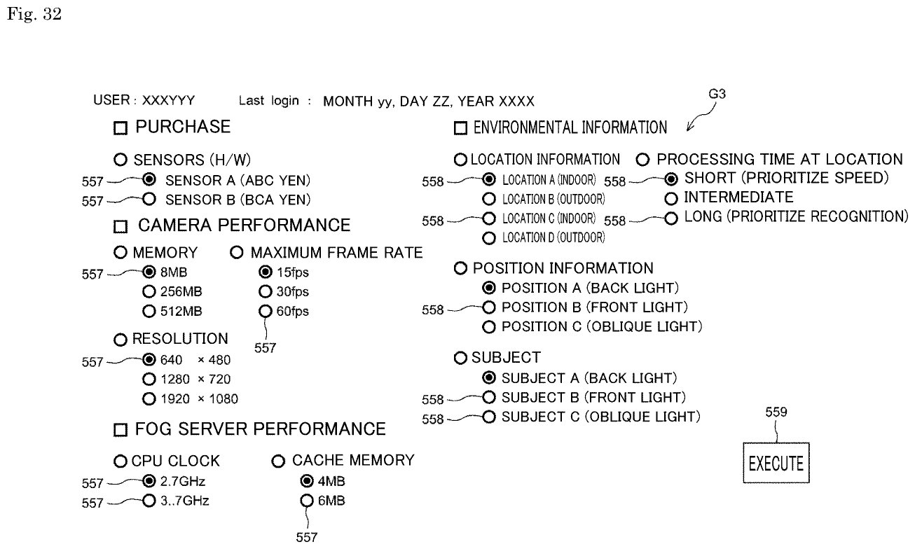

FIG. 32 is an example of a user's screen G3 that is presented to a user (the application-using user described above) who performs various kinds of analysis or the like by, for example, deploying an AI application or an AI model to the camera 403 as an edge-side information processing apparatus managed by the user himself/herself.

The user can purchase, via the marketplace, the camera 403 to be arranged in a space that is an object of surveillance. Therefore, a radio button 557 that enables a type and a performance of the image sensor IS mounted to the camera 403, a performance of the camera 403, and the like to be selected is arranged on a left side of the user's screen G3.

In addition, the user can purchase, via the marketplace, an information processing apparatus as the fog server 404. Therefore, the radio button 557 for selecting various performances of the fog server 404 is arranged on the left side of the user's screen G3.

Furthermore, a user already in possession of the fog server 404 can register the performance of the fog server 404 by entering performance information of the fog server 404 on the user's screen G3.

While a user can achieve a desired function by installing the purchased cameras 403 (or cameras 403 purchased without involving the marketplace) at any location such as a store managed by the user himself/herself, the marketplace enables the user to register information on the installation location of the cameras 403 in order to maximize the function of each camera 403.

A radio button 558 that enables environmental information on an environment in which the camera 403 is installed to be selected is arranged on a right side of the user's screen G3. The user can configure the object camera 403 to the optimum imaging settings described above by appropriately selecting environmental information on the environment in which the camera 403 is installed.

When an installation location of the camera 403 that is planned to be purchased has been determined by the time of purchase of the camera 403, the camera 403 configured in advance to optimum imaging settings in accordance with the planned installation location can be purchased by selecting the respective left-side items and the respective right-side items of the user's screen G3.

The user's screen G3 is provided with an execute button 559. By depressing the execute button 559, a transition is made to a confirmation screen for confirming purchases or a confirmation screen for checking settings of environmental information. Accordingly, the user can purchase a desired camera 403 or fog server 404 and configure settings of environmental information with respect to the camera 403.

The marketplace enables environmental information of each camera 403 to be changed in anticipation of a change in the installation location of the camera 403. Re-entering environmental information on the installation location of the camera 403 on a change screen (not illustrated) enables optimum imaging settings of the camera 403 to be reconfigured.

### 4. Modifications

While an example where an AI model and a data set generated by development processing of an AI model and a data set as mining processing of a blockchain are purchased in the marketplace has been described above, separately, an AI model and an AI application developed by the AI model developer terminal 402C and the application developer terminal 402A may be made available for use by the application user terminal 402B.

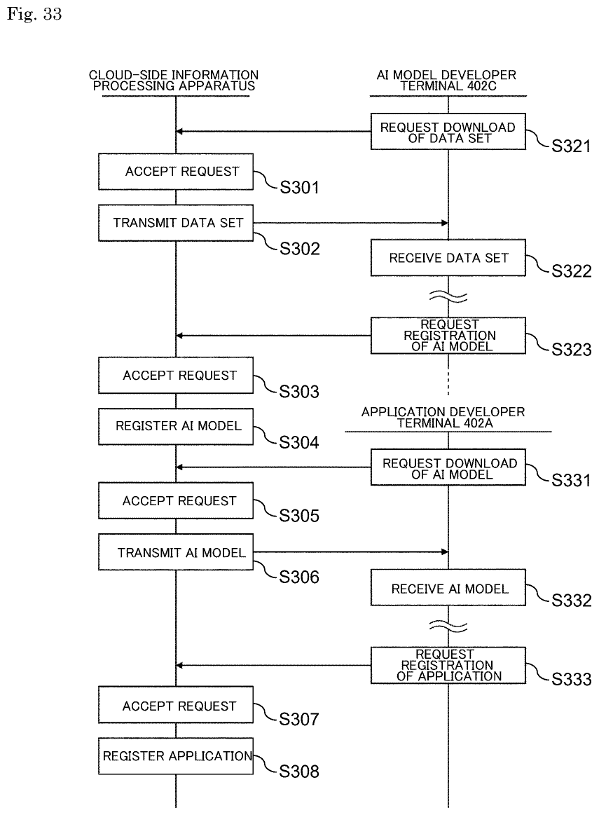

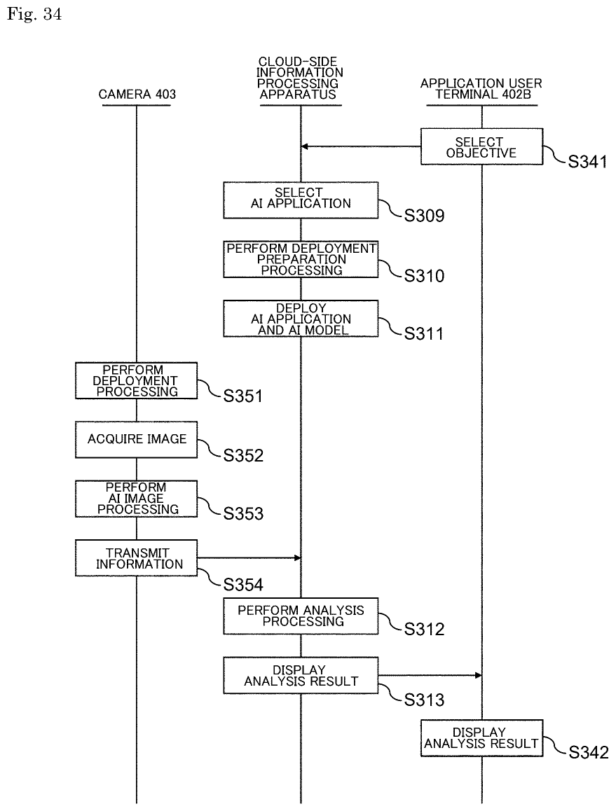

The processing will now be described with reference to the flow charts shown in FIGS. 33 and 34.

The cloud server 401, the management server 405, and the like in FIG. 20 correspond to cloud-side information processing apparatuses.

In response to an AI model developer viewing a list of data sets registered in the marketplace using the AI model developer terminal 402C including a display unit constituted of an LCD (Liquid Crystal Display), an organic EL (Electro Luminescence) panel, or the like and selecting a desired data set, in step S321 (FIG. 33), the AI model developer terminal 402C transmits a download request for the selected data set to a cloud-side information processing apparatus.

In step S301, the cloud-side information processing apparatus accepts the request and, in step S302, performs processing of transmitting the requested data set to the AI model developer terminal 402C.

In step S322, the AI model developer terminal 402C performs processing of receiving the data set. Accordingly, the AI model developer can develop an AI model using the data set.

Once the AI model developer finishes the development of the AI model and subsequently performs an operation for registering the developed AI model to the marketplace (for example, by designating a name of the AI model or an address where the AI model is placed), in step S323, the AI model developer terminal 402C transmits a registration request of the AI model to the marketplace to the cloud-side information processing apparatus.

In step S303, the cloud-side information processing apparatus accepts the registration request, and in step S304, performs registration processing of the AI model to cause, for example, the AI model to be displayed on the marketplace.

Accordingly, users other than the AI model developer become capable of downloading the AI model from the marketplace.

For example, an application developer desiring to develop an AI application views a list of AI models registered in the marketplace using the application developer terminal 402A. In accordance with an operation by the application developer (for example, an operation of selecting one of the AI models on the marketplace), in step S331, the application developer terminal 402A transmits a download request of the selected AI model to the cloud-side information processing apparatus.

The cloud-side information processing apparatus accepts the request in step S305 and, in step S306, transmits the AI model to the application developer terminal 402A.

In step S332, the application developer terminal 402A receives the AI model. Accordingly, the application developer can develop an AI application using an AI model developed by another person.

Once the application developer finishes the development of the AI application and subsequently performs an operation for registering the AI application to the marketplace (for example, by designating a name of the AI application or an address where the AI model is placed), in step S333, the application developer terminal 402A transmits a registration request of the AI application to the cloud-side information processing apparatus.

In step S307, the cloud-side information processing apparatus accepts the registration request, and in step S308, performs registration of the AI application to cause, for example, the AI application to be displayed on the marketplace. Accordingly, users other than the application developer become capable of selecting the AI application on the marketplace and downloading the AI application.

For example, as shown in FIG. 34, in step S341, a user who desires to use an AI application selects an objective through the application user terminal 402B. In the objective selection, the selected objective is transmitted to the cloud-side information processing apparatus.

In step S309, the cloud-side information processing apparatus selects an AI application according to the objective and, in step S310, performs preparation processing (deployment preparation processing) for deploying an AI application or an AI model to each apparatus.

In the deployment preparation processing, determination of an AI model and the like is performed in accordance with information on an apparatus to be an object of the deployment processing of an AI model or an AI application such as information on the camera 403 or the fog server 404 or performance requested by the user.

In addition, in the deployment preparation processing, a determination is made as to which apparatus is to execute each SW (Software) component that constitutes an AI application for realizing the function desired by the user based on performance information of each apparatus and request information of the user.

Each SW component may be either a container or a microservice. An SW component can also be realized using WebAssembly technology.

An AI application that counts the number of customers to a store by attributes including gender and age would include a SW component that detects human faces from captured images using an AI model, a SW component that extracts human attribute information from results of the face detection, a SW component that aggregates the results, and a SW component that visualizes the aggregate results.

In step S311, the cloud-side information processing apparatus performs processing of deploying each SW component to each apparatus. In the processing, an AI application and an AI model are transmitted to each apparatus such as the camera 403.

In response thereto, in the camera 403, deployment processing of the AI application and the AI model is performed in step S351. Accordingly, AI image processing can be performed with respect to a captured image taken by the camera 403.

Although not shown in FIG. 34, deployment processing of an AI application and an AI model is similarly performed in the fog server 404 when necessary.

However, when all processing is to be executed in the camera 403, deployment processing with respect to the fog server 404 is not performed.

In step S352, the camera 403 acquires an image by performing an imaging operation. In addition, in step S353, the camera 403 performs AI image processing with respect to the acquired image and obtains, for example, an image recognition result.

In step S354, the camera 403 performs transmission processing of a captured image and result information of AI image processing. In the information transmission in step S354, both the captured image and the result information of AI image processing may be transmitted or only one of the captured image and the result information may be transmitted.

In step S312, the cloud-side information processing apparatus having received the information performs analysis processing. Due to the analysis processing, for example, flow line analysis of customers, vehicle analysis processing for traffic surveillance, or the like is performed.

In step S313, the cloud-side information processing apparatus performs presentation processing of an analysis result. For example, this processing is realized due to the user using the cloud application described above.

The application user terminal 402B receives presentation processing of the analysis result and, in step S342, performs processing of causing the analysis result to be displayed on a monitor or the like.

Due to processing up to this point, the user who is a user of the AI application can obtain an analysis result according to the objective selected in step S341.

The cloud-side information processing apparatus may update the AI model after step S313. Updating and deploying the AI model enables an analysis result suitable for the usage environment of the user to be obtained.

### 5. Example of Execution by Software

The series of processing described above can be executed by hardware or by software. When executing the series of processing by software, a program constituting the software is installed from a recording medium to a computer that is built into dedicated hardware or to a general-purpose personal computer or the like capable of executing various functions when various programs are installed therein.

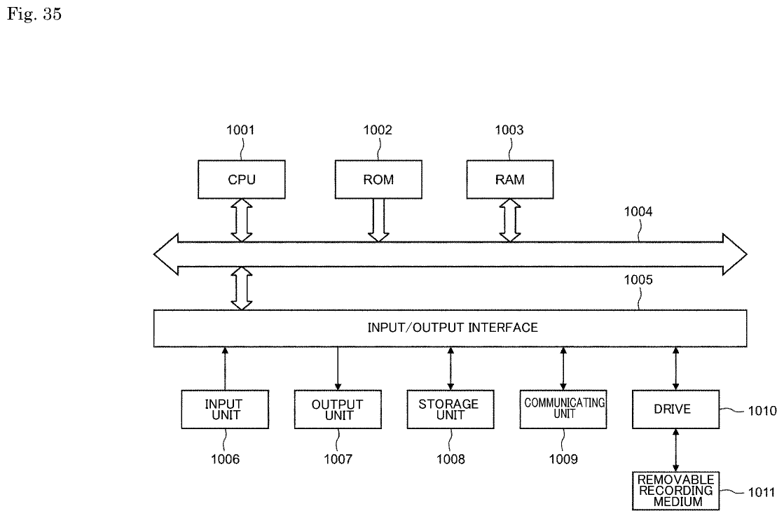

FIG. 35 shows a configuration example of a general-purpose computer. The computer has a built-in CPU (Central Processing Unit) 1001. An input/output interface 1005 is connected to the CPU 1001 via a bus 1004. A ROM (Read Only Memory) 1002 and a RAM (Random Access Memory) 1003 are connected to the bus 1004.

An input unit 1006 constituted of an input device such as a keyboard or a mouse that is used by the user to input an operation command; an output unit 1007 that outputs a processing operation screen and an image of a processing result to a display device; a storage unit 1008 constituted of a hard disk drive or the like that stores programs and various kinds of data; and a communicating unit 1009 constituted of a LAN (Local Area Network) adapter or the like that executes communication processing over a network as typified by the Internet are connected to the input/output interface 1005. In addition, a drive 1010 that writes and reads data to and from a removable storage medium 1011 that is a magnetic disk (including a flexible disk), an optical disk (including a CD-ROM (Compact Disc-Read Only Memory) or a DVD (Digital Versatile Disc)), a magneto-optical disk (including an MD (Mini Disc)), a semiconductor memory, or the like is connected.

The CPU 1001 executes various kinds of processing in accordance with a program stored in a ROM 1002 or a program read from the removable storage medium 1011 that is a magnetic disk, an optical disk, a magneto-optical disk, a semiconductor memory, or the like, installed in the storage unit 1008, and loaded from the storage unit 1008 onto the RAM 1003. The RAM 1003 also stores, when appropriate, data required by the CPU 1001 to execute the various kinds of processing.

In the computer configured as described above, the series of processing described earlier is performed as, for example, the CPU 1001 loads a program stored in the storage unit 1008 onto the RAM 1003 via the input/output interface 1005 and the bus 1004 and executes the program.

For example, the program executed by the computer (the CPU 1001) can be provided by being recorded on the removable storage medium 1011 as a packaged medium or the like. Alternatively, the program can be provided via a wired or wireless transmission medium such as a local area network, the Internet, or digital satellite broadcasting.

In the computer, the program can be installed in the storage unit 1008 via the input/output interface 1005 by mounting the removable storage medium 1011 to the drive 1010. In addition, the program can be received by the communicating unit 1009 via a wired or wireless transmission medium and installed in the storage unit 1008. Alternatively, the program can be installed in the ROM 1002 or the storage unit 1008 in advance.

The program to be executed by the computer may be a program which causes processing to be time-sequentially performed along the orders described in the present specification or a program which causes processing to be performed in parallel or at necessary timings such as when a call is made.

Note that the CPU 1001 in FIG. 35 realizes functions of the control unit 141 in FIG. 10, the control unit 171 in FIG. 11, and the CPU 471 in FIG. 28.

In addition, in the present specification, a system signifies a set of a plurality of components (apparatuses, modules (parts), and the like), and whether or not all of the components are present inside the same casing does not matter. Therefore, a plurality of apparatuses which are housed in separate casings but which are connected to each other via a network and a single apparatus in which a plurality of modules are housed in a single casing are both considered systems.

Embodiments of the present disclosure are not limited to the embodiment described above and various modifications can be made without departing from the gist of the present disclosure.

For example, the present disclosure may adopt a configuration of cloud computing in which a single function is shared among and cooperatively processed by a plurality of apparatuses via a network.

In addition, each step explained in the flow charts described above can be executed in a shared manner by a plurality of apparatuses in addition to being executed by a single apparatus.

Furthermore, when a single step includes a plurality of processing steps, the plurality of processing steps included in the single step can be executed in a shared manner by a plurality of apparatuses in addition to being executed by a single apparatus.

Note that the present disclosure can also be configured as follows.
<1> An information processing apparatus, including
a search unit configured to add a new block containing an identifier of the information processing apparatus to a blockchain held by each of a group of a plurality of distributed information processing apparatuses when the search unit searches for information that satisfies a predetermined condition first, wherein the information that satisfies the predetermined condition is an input setting value with respect to useful calculation processing that satisfies an evaluation condition of a predetermined output result.
<2> The information processing apparatus according to <1>, wherein
the evaluation condition of the predetermined output result is based on an evaluated value when an AI model is applied to a data set.
<3> The information processing apparatus according to <1>, wherein
the input setting value with respect to useful calculation processing is a parameter of an AI model.
<4> The information processing apparatus according to any one of <1> to <3>, wherein
the input setting value with respect to useful calculation processing is an input setting value for which a request for search is issued from a requestor terminal operated by a requestor who requests a search for the information that satisfies the predetermined condition.
<5> The information processing apparatus according to <4>, wherein
the request for search is broadcasted to a plurality of information processing apparatuses via a smart contract, and
the search unit is configured to acquire the request for search via the smart contract.
<6> The information processing apparatus according to <5>, wherein
the search unit is configured to acquire information necessary for the search for the information that satisfies the predetermined condition via the smart contract.
<7> The information processing apparatus according to <6>, wherein
the search unit is configured to search using a parameter of an AI model satisfying a predetermined condition as the input setting value, and
the information necessary for the search for the information that satisfies the predetermined condition includes a software simulator configured to execute an operation simulating the AI model by being executed and an evaluation tool configured to output an evaluation index with respect to an execution result of the software simulator.
<8> The information processing apparatus according to <7>, wherein
the search unit is configured to repeatedly perform processing of executing the operation simulating the AI model while changing a setting value corresponding to the parameter of the AI model in the software simulator and causing the evaluation tool to output an evaluation index with respect to the execution result and to search for a parameter of the AI model satisfying the predetermined condition based on the evaluation index.
<9> The information processing apparatus according to <8>, wherein
the search unit is configured to broadcast, when the search unit is able to search a parameter of the AI model satisfying the predetermined condition first based on the evaluation index, the setting value of the software simulator via the smart contract as the parameter of the AI model that the search unit is able to search.
<10> The information processing apparatus according to <9>, wherein
the AI model is configured to function as:
a mask configured to modulate incident light;
an imaging element configured to capture modulated light having been modulated by the mask; and
a reconstruction unit in a lensless imaging apparatus, the reconstruction unit being constituted of a neural network and configured to reconstruct a reconstructed image corresponding to a current image constituted of the incident light from a modulated image constituted of the modulated light,
the software simulator is configured to execute an operation simulating the reconstruction unit by causing the AI model to function and sequentially reconstruct the reconstructed image while changing a setting value corresponding to the parameter that sets a weight of a hidden layer in the neural network constituting the reconstruction unit,
the evaluation tool is configured to output an evaluation index with respect to the reconstructed image that is reconstructed by the software simulator, and
the search unit is configured to search for a parameter of the AI model that operates so that the evaluation index becomes higher than a predetermined evaluation index.
<11> The information processing apparatus according to <9>, wherein
the requestor terminal is configured to configure a setting value of the software simulator according to the broadcasted parameter of the AI model, operate the software simulator, and verify whether or not an operation simulating the AI model satisfying the predetermined condition is to be executed.
<12> The information processing apparatus according to <11>, wherein
the requestor terminal is configured to cause the software simulator to execute an operation simulating the AI model according to the broadcasted parameter of the AI model, and cause the evaluation tool to output the evaluation index with respect to the execution result to verify that the operation simulating the AI model satisfying the predetermined condition is to be executed.
<13> The information processing apparatus according to <12>, wherein
when it is verified that an operation simulating an AI model satisfying the predetermined condition is to be executed,
the requestor terminal is configured to add the new block to the blockchain.
<14> The information processing apparatus according to <10>, further including a verifying unit configured to be searched by another information processing apparatus and to verify that an operation simulating an AI model satisfying the predetermined condition is to be executed by configuring a setting value of the software simulator according to the broadcasted parameter of the AI model, executing the software simulator, and causing the evaluation tool to output the evaluation index with respect to the execution result.
<15> The information processing apparatus according to <14>, wherein
when it is verified that the operation simulating the AI model satisfying the predetermined condition is to be executed,
the search unit is configured to add a new block including an identifier of the other information processing apparatus to the blockchain.
<16> An information processing method, including the step of
adding a new block containing an own identifier to a blockchain held by each of a group of a plurality of distributed information processing apparatuses when information that satisfies a predetermined condition is searched first, wherein the information that satisfies a predetermined condition is an input setting value with respect to useful calculation processing that satisfies an evaluation condition of a predetermined output result.
<17> A program, causing a computer to function as a search unit that adds a new block containing an own identifier to a blockchain held by each of a group of a plurality of distributed information processing apparatuses when the search unit searches for information that satisfies a predetermined condition first, wherein the information that satisfies the predetermined condition is an input setting value with respect to useful calculation processing that satisfies an evaluation condition of a predetermined output result.

### REFERENCE SIGNS LIST

111 Information processing system
121, 121-1 to 121-n AI model developer terminal
122 AI model development requestor terminal
123 AI model developer site management server
124 Management site management server
151 Mining processing unit
152 Verification processing unit
181 Request processing unit
401 Cloud server (information processing apparatus, cloud-side information processing apparatus)
403, 403A, 403B, 403C Camera (edge-side information processing apparatus)
404 Fog server (edge-side information processing apparatus)
405 Management server (information processing apparatus, cloud-side information processing apparatus)
IS Image sensor (edge-side information processing apparatus)
F5 Camera service function (determination processing unit)

What is claimed is:

1. An information processing apparatus, comprising
a search unit configured to add a new block containing an identifier of the information processing apparatus to a blockchain held by each of a group of a plurality of distributed information processing apparatuses when the search unit searches for information that satisfies a predetermined condition first, wherein
the information that satisfies the predetermined condition is an input setting value with respect to useful calculation processing that satisfies an evaluation condition of a predetermined output result.

2. The information processing apparatus according to claim 1, wherein
the evaluation condition of the predetermined output result is based on an evaluated value when an AI model is applied to a data set.

3. The information processing apparatus according to claim 1, wherein
the input setting value with respect to useful calculation processing is a parameter of an AI model.

4. The information processing apparatus according to claim 1, wherein
the input setting value with respect to useful calculation processing is an input setting value for which a request for search is issued from a requestor terminal operated by a requestor who requests a search for the information that satisfies the predetermined condition.

5. The information processing apparatus according to claim 4, wherein
the request for search is broadcasted to a plurality of information processing apparatuses via a smart contract, and
the search unit is configured to acquire the request for search via the smart contract.

6. The information processing apparatus according to claim 5, wherein
the search unit is configured to acquire information necessary for the search for the information that satisfies the predetermined condition via the smart contract.

7. The information processing apparatus according to claim 6, wherein
the search unit is configured to search using a parameter of an AI model satisfying a predetermined condition as the input setting value, and
the information necessary for the search for the information that satisfies the predetermined condition includes a software simulator configured to execute an operation simulating the AI model by being executed and an evaluation tool configured to output an evaluation index with respect to an execution result of the software simulator.

8. The information processing apparatus according to claim 7, wherein
the search unit is configured to repeatedly perform processing of executing the operation simulating the AI model while changing a setting value corresponding to the parameter of the AI model in the software simulator and causing the evaluation tool to output an evaluation index with respect to the execution result and to search for a parameter of the AI model satisfying the predetermined condition based on the evaluation index.

9. The information processing apparatus according to claim 8, wherein
the search unit is configured to broadcast, when the search unit is able to search a parameter of the AI model satisfying the predetermined condition first based on the evaluation index, the setting value of the software simulator via the smart contract as the parameter of the AI model that the search unit is able to search.

10. The information processing apparatus according to claim 9, wherein
the AI model is configured to function as:
a mask configured to modulate incident light;
an imaging element configured to capture modulated light having been modulated by the mask; and
a reconstruction unit in a lensless imaging apparatus, the reconstruction unit being constituted of a neural network and configured to reconstruct a reconstructed image corresponding to a current image constituted of the incident light from a modulated image constituted of the modulated light,
the software simulator is configured to execute an operation simulating the reconstruction unit by causing the AI model to function and sequentially reconstruct the reconstructed image while changing a setting value corresponding to the parameter that sets a weight of a hidden layer in the neural network constituting the reconstruction unit,
the evaluation tool is configured to output an evaluation index with respect to the reconstructed image that is reconstructed by the software simulator, and
the search unit is configured to search for a parameter of the AI model that operates so that the evaluation index becomes higher than a predetermined evaluation index.

11. The information processing apparatus according to claim 9, wherein
the requestor terminal is configured to configure a setting value of the software simulator according to the broadcasted parameter of the AI model, operate the software simulator, and verify whether or not an operation simulating the AI model satisfying the predetermined condition is to be executed.

12. The information processing apparatus according to claim 11, wherein
the requestor terminal is configured to cause the software simulator to execute an operation simulating the AI model according to the broadcasted parameter of the AI model, and cause the evaluation tool to output the evaluation index with respect to the execution result to verify that the operation simulating the AI model satisfying the predetermined condition is to be executed.

13. The information processing apparatus according to claim 12, wherein
when it is verified that an operation simulating an AI model satisfying the predetermined condition is to be executed,
the requestor terminal is configured to add the new block to the blockchain.

14. The information processing apparatus according to claim 10, further comprising a verifying unit configured to be searched by another information processing apparatus and to verify that an operation simulating an AI model satisfying the predetermined condition is to be executed by configuring a setting value of the software simulator according to the broadcasted parameter of the AI model, executing the software simulator, and causing the evaluation tool to output the evaluation index with respect to the execution result.

15. The information processing apparatus according to claim 14, wherein
when it is verified that the operation simulating the AI model satisfying the predetermined condition is to be executed,
the search unit is configured to add a new block including an identifier of the other information processing apparatus to the blockchain.

16. An information processing method, comprising the step of
adding a new block containing an own identifier to a blockchain held by each of a group of a plurality of distributed information processing apparatuses when information that satisfies a predetermined condition is searched first, wherein the information that satisfies the predetermined condition is an input setting value with respect to useful calculation processing that satisfies an evaluation condition of a predetermined output result.

17. A program, causing a computer to function as a search unit that adds a new block containing an own identifier to a blockchain held by each of a group of a plurality of distributed information processing apparatuses when the search unit searches for information that satisfies a predetermined condition first, wherein
the information that satisfies the predetermined condition is an input setting value with respect to useful calculation processing that satisfies an evaluation condition of a predetermined output result.
